(19) United States
(12) Patent Application Publication
(10) Pub. No.: US 2026/0312288 A1
(43) Pub. Date: Oct. 8, 2026

(54) ANTENNA DEVICE AND ELECTRONIC APPARATUS

(71) Applicant: SONY GROUP CORPORATION, TOKYO (JP)

(72) Inventors: YUKIO KANEKO, TOKYO (JP); TAKASHI KAWAMURA, TOKYO (JP)

(21) Appl. No.: 19/483,632

(22) PCT Filed: Apr. 16, 2024
(86) PCT No.: PCT/JP2024/015069

§ 371 Date: Nov. 12, 2025

(30) Foreign Application Priority Data
May 23, 2023 (JP) 2023-084318

(51) Int. Cl. H01Q 7/00; H01Q 1/24; H01Q 1/38; H02J 50/27

(52) U.S. Cl. CPC H01Q 7/00; H01Q 1/248; H01Q 1/38; H02J 50/27

(57) ABSTRACT

To improve gain and efficiency of an antenna included in a rectenna. An antenna device including: a first conductor having a loop shape; a rectifier circuit connected to the first conductor; and a second conductor having a plate shape and including a main surface extending in a direction substantially orthogonal to a loop surface of the first conductor, and an outer edge part of the main surface, in which the first conductor has a loop whose length with respect to a wavelength at a reception frequency is larger than 0.15, and the second conductor has the outer edge part whose minimum length with respect to the length of the loop of the first conductor is larger than 0.4.

### TECHNICAL FIELD

The present technology relates to an antenna device and an electronic apparatus.

### BACKGROUND ART

As a technical trend of wireless power transfer, for example, three radio bands of 920 MHz, 2.4 GHz, and 5.7 GHZ are used in microwave wireless power transfer in Japan, and a wireless power transfer system using three radio bands has been legalized in May 2022. In the future, realization of a wireless power transfer system using not microwaves but waves of a higher radio band (for example, a millimeter wave band around 28 GHZ or a higher frequency band around 60 GHZ) has also been sought.

These radio wave bands are also considered to be used in a fifth generation mobile communication system (so-called 5G), Beyond 5G, 6G, or the like obtained by developing 5G, and a combination of these communication systems and wireless power transfer is also considered. As a power supply system using wireless power transfer, not only power supply to Internet of Things (IoT) devices but also power supply to mobile devices and application of making universal serial bus (USB) wireless are expected.

One of the technical elements for realizing wireless power transfer is a rectenna. The rectenna is an abbreviation for rectifying antenna. The rectenna is a device that receives electromagnetic wave energy in space by an antenna, converts the electromagnetic wave energy into a direct current (DC) voltage by a rectifier circuit, and outputs the DC voltage. For example, Non-Patent Document 1 below describes a rectenna mainly intended to be used in a low frequency band of mainly 920 MHz band. The rectenna has a loop-shaped pattern printed on a card-type substrate.

### CITATION LIST

### Patent Document

Non-Patent Document 1: Yuki Muramoto, Naoki Sakai, Kenji Ito, “A 920 MHz band rectenna with impedance transformed small loop antenna.” IEICE Conferences Archives. The Institute of Electronics, Information and Communication Engineers, 2021.

### SUMMARY OF THE INVENTION

### Problems to be Solved by the Invention

In a high frequency band such as a millimeter wave band, it is important to increase the gain and the efficiency of the antenna included in the rectenna. However, in the configuration of the rectenna described in Non-Patent Document 1, it is difficult to achieve a high gain required in a high frequency band. Furthermore, in a case where the rectenna is bonded to a metal surface in a device, there is a possibility that the efficiency is greatly reduced.

An object of the present technology is to provide an antenna device in which the efficiency of an antenna included in a rectenna is improved and an electronic apparatus having the antenna device.

### Solutions to Problems

The present technology is, for example, an antenna device including:
a first conductor having a loop shape;
a rectifier circuit connected to the first conductor; and
a second conductor having a plate shape and including a main surface extending in a direction substantially orthogonal to a loop surface of the first conductor, and an outer edge part of the main surface,
in which
the first conductor has a loop whose length with respect to a wavelength at a reception frequency is larger than 0.15, and the second conductor has the outer edge part whose minimum length with respect to the length of the loop of the first conductor is larger than 0.4.

The present technology may be an electronic apparatus having such an antenna device.

### BRIEF DESCRIPTION OF DRAWINGS

A and B of FIG. 1 are diagrams referred to at the time when a physical background related to the present technology is described.

A and B of FIG. 2 are diagrams referred to at the time when a physical background related to the present technology is described.

A to C of FIG. 3 are diagrams for explaining an antenna device according to a first embodiment.

FIG. 4 is a diagram for explaining the antenna device according to the first embodiment.

FIG. 5 is a diagram illustrating an example of directional characteristics of the antenna device according to the first embodiment.

FIG. 6 is a diagram illustrating an example of a simulation result illustrating a relationship between a maximum gain and a loop length.

FIG. 7 is a diagram illustrating an example of a simulation result illustrating a relationship between a maximum gain and the size of a metal plate.

A and B of FIG. 8 are diagrams for explaining an antenna device according to a second embodiment.

A and B of FIG. 9 are diagrams for explaining an antenna device according to a third embodiment.

A to C of FIG. 10 are diagrams for explaining an antenna device according to a fourth embodiment.

A and B of FIG. 11 are diagrams for explaining an antenna device according to a fifth embodiment.

FIG. 12 is a simulation result illustrating a relationship between a maximum gain and a length of a loop upper surface.

A and B of FIG. 13 are diagrams for explaining an antenna device according to a sixth embodiment.

FIG. 14 is a simulation result illustrating a relationship between a radiation efficiency and a width of a loop upper surface.

A to C of FIG. 15 are diagrams for explaining an antenna device according to a seventh embodiment.

A and B of FIG. 16 are diagrams for explaining a modification of the seventh embodiment.

FIG. 17 is a diagram for explaining a modification of the seventh embodiment.

A and B of FIG. 18 are diagrams for explaining an antenna device according to an eighth embodiment.

A and B of FIG. 19 are diagrams for explaining a modification of the eighth embodiment.

A and B of FIG. 20 are diagrams for explaining a modification of the eighth embodiment.

A to C of FIG. 21 are diagrams for explaining an antenna device according to a ninth embodiment.

A and B of FIG. 22 are diagrams for explaining an antenna device according to a tenth embodiment.

A and B of FIG. 23 are diagrams for explaining a modification of the tenth embodiment.

A to C of FIG. 24 are diagrams for explaining an antenna device according to an eleventh embodiment.

A to C of FIG. 25 are diagrams for explaining a modification of the eleventh embodiment.

A to C of FIG. 26 are diagrams for explaining an antenna device according to a twelfth embodiment.

A to C of FIG. 27 are diagrams for explaining an antenna device according to a thirteenth embodiment.

FIG. 28 is a diagram for explaining an antenna device according to a fourteenth embodiment.

FIG. 29 is a diagram for explaining a modification of the fourteenth embodiment.

A and B of FIG. 30 are diagrams for explaining an application example of the present technology.

A and B of FIG. 31 are diagrams for explaining a modification.

A and B of FIG. 32 are diagrams for explaining a modification.

A to C of FIG. 33 are diagrams for explaining a modification.

FIG. 34 is a diagram for explaining a modification.

FIG. 35 is a diagram for explaining a modification.

FIG. 36 is a diagram for explaining a modification.

### MODE FOR CARRYING OUT THE INVENTION

Embodiments and the like of the present technology are described below with reference to the drawings. Note that the embodiments and the like to be described below are preferred specific examples of the present technology, and the content of the present technology is not limited to the embodiments and the like. Note that the sizes, the positional relationships of the members, and the like in each of the drawings are exaggerated in some cases for clarity of description, and furthermore, there is a case where only some of reference numerals are illustrated or the illustration is partially simplified in order to prevent the illustration from becoming complicated. Moreover, in the description below, the same names or the same reference numerals denote the same or similar members, and redundant descriptions are omitted in some cases as appropriate.

The description will be given in the following order.
[Physical background]
[First embodiment]
[Second embodiment]
[Third embodiment]
[Fourth embodiment]
[Fifth embodiment]
[Sixth embodiment]
[Seventh embodiment]
[Eighth embodiment]
[Ninth embodiment]
[Tenth embodiment]
[Eleventh embodiment]
[Twelfth embodiment]
[Thirteenth embodiment]
[Fourteenth embodiment]
[Application example]
[Modifications]

### [Physical Background]

First, a physical background will be described with reference to FIGS. 1 and 2 in order to facilitate understanding of the present technology. In general, when a circular electric current is generated in a surface perpendicular to one surface of a metal surface, the metal surface acts like a mirror, and an electric current component flowing at a position symmetrical to the metal surface is also generated in a surface perpendicular to the other surface of the metal surface. This phenomenon is called a mirror image effect.

As illustrated in FIGS. 1A and 1B, an example in which a dipole antenna 2 is disposed close to a metal surface 1 of metal will be considered. The dipole antenna 2 has a rod-shaped element (an antenna element) 2A disposed close to the metal surface 1, and a high frequency signal source 2B is connected to the element 2A. As illustrated in FIG. 1A, when the element 2A is disposed perpendicularly to the metal surface 1, an electric current component (indicated by an arrow in FIG. 1A) is also generated at a position symmetrical with respect to the metal surface 1 due to the mirror image effect, whereby radiation of radio waves in a specific direction becomes dominant (mutually intensified). On the other hand, as illustrated in FIG. 1B, when the element 2A is disposed in parallel to the metal surface 1, an electric current component generated at a position symmetric with respect to the metal surface 1 due to the mirror image effect is in a direction opposite to an electric current component flowing through the element 2A. That is, the electric currents flowing in the horizontal direction are cancelled out by the electric currents flowing in directions opposite to each other, and are mutually weakened.

Next, as illustrated in FIGS. 2A, 2B, an example in which a loop antenna 3 is disposed close to the metal surface 1 of metal will be considered. The loop antenna 3 includes, for example, an element 3A forming a circular loop surface, and a high-frequency signal source 3B is connected to the element 3A.

As shown in FIG. 2A, when the loop antenna 3 is disposed such that the loop surface of the element 3A is parallel to the metal surface 1 and an electric current is made to flow through the element 3A, a magnetic current component is generated in a manner of penetrating the loop surface. Furthermore, a magnetic current component in the opposite direction is generated at a symmetrical position on the opposite side of the metal surface 1 due to the mirror image effect. The magnetic current components generated on both sides of the metal surface 1 are reversed and cancelled out, so that the magnetic current components are mutually weakened.

On the other hand, as illustrated in FIG. 2B, when the loop surface of the element 3A is disposed to become perpendicular to the metal surface 1, a magnetic current component in the same direction is generated at a symmetrical position on the opposite side of the metal surface 1 due to the mirror image effect, and the magnetic current components are mutually intensified.

That is, by disposing the loop surface of the loop antenna perpendicularly to the metal surface, a high gain (antenna gain) can be obtained while a decrease in efficiency is suppressed. In other words, the gain and the efficiency of the antenna can be improved, and thus, an antenna device suitable as a rectenna can be obtained. Note that the efficiency of the antenna means a ratio of power that can be output to power input to the antenna, and an antenna having a higher gain means an antenna that radiates radio waves in a more specific direction. Based on the above, specific embodiments of the present technology will be described.

### First Embodiment

### (Configuration Example of Antenna Device)

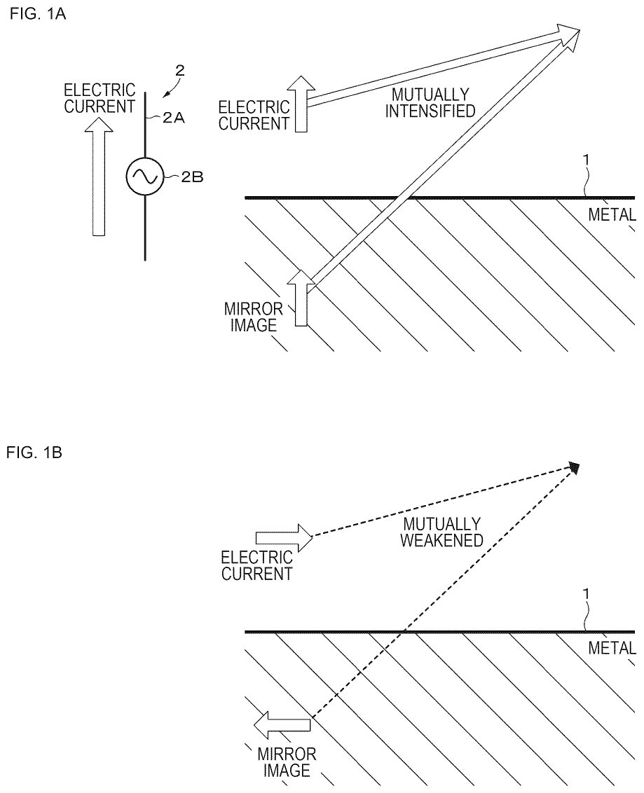

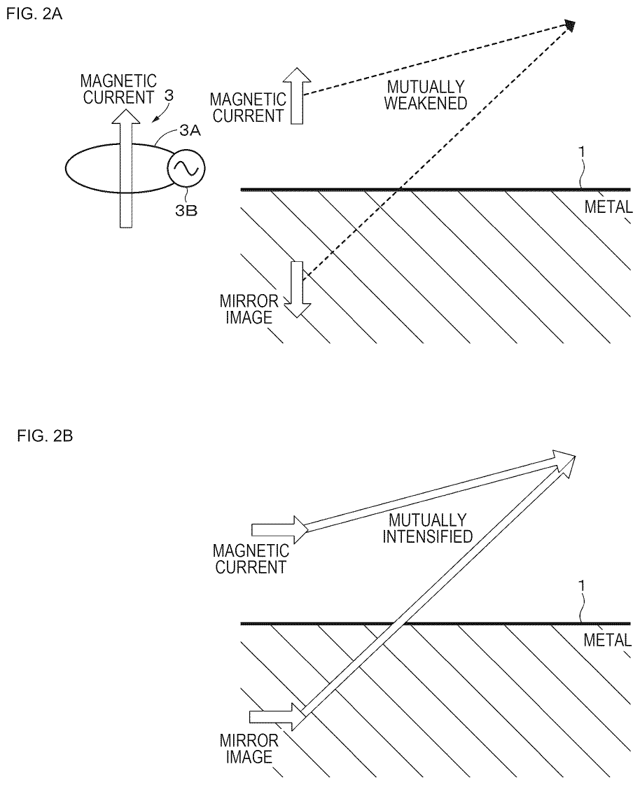

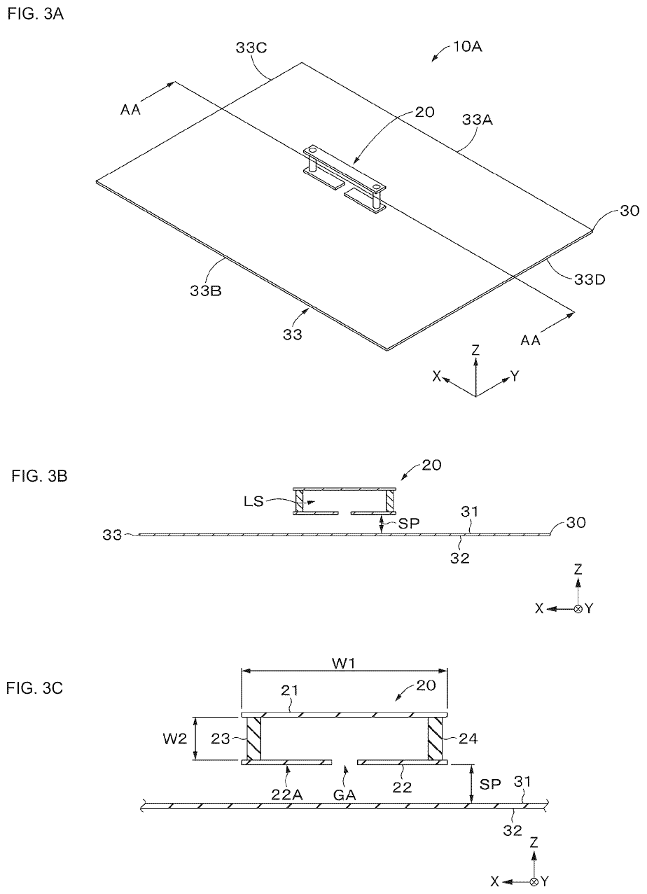

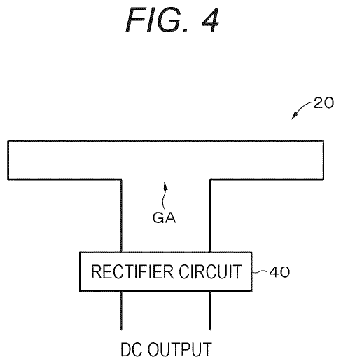

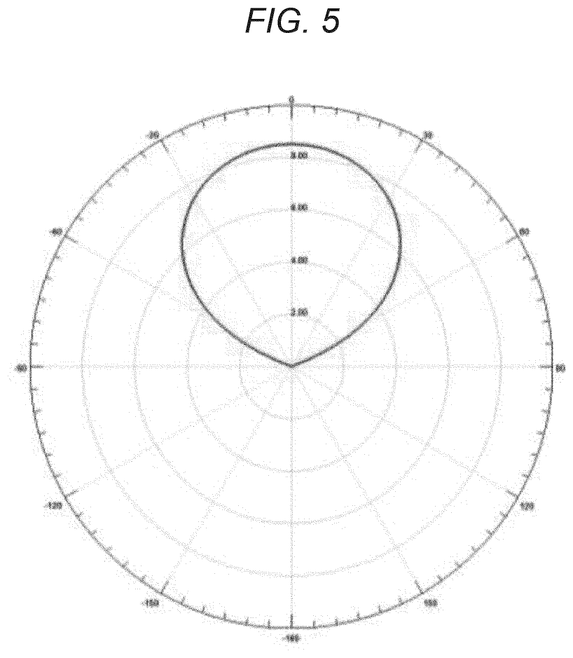

A configuration example of an antenna device (an antenna device 10A) according to a first embodiment will be described with reference to FIGS. 3A, 3B, 3C, and 4. Note that an antenna device according to each embodiment and modification described below is a device that operates as a rectenna.

FIG. 3A is a perspective view of an antenna device 10A, FIG. 3B is a cross-sectional view in a case where the antenna device 10A is cut along a cutting line AA-AA in FIG. 3A, and FIG. 3C is a partially enlarged view in which a part of FIG. 3B is enlarged. Note that, in the present embodiment, the X axis, the Y axis, and the Z axis are in an orthogonal relationship to each other, the X axis and the Y axis are axes in a predetermined plane, and the Z axis is an axis orthogonal to the predetermined plane. This also applies to other embodiments and modifications.

As illustrated in FIG. 3A, the antenna device 10A includes a first conductor 20 and a metal plate 30 disposed close to the first conductor 20. For example, the metal plate 30 corresponds to a second conductor.

The first conductor 20 is, for example, a loop antenna. As the material of the first conductor 20, for example, a conductive metal such as copper or gold is used, but the material is not limited thereto as long as the material has relatively high conductivity. The first conductor 20 is formed by, for example, laser processing or laser direct structuring (LDS). As illustrated in FIG. 3C, the first conductor 20 includes, for example, a first element 21, a second element 22 disposed to face the first element 21, a third element 23 extending in a direction (the Z direction in the present example) substantially orthogonal to the extending direction of the first element 21 and the second element 22, and a fourth element 24 disposed to face the third element 23.

The first element 21 and the second element 22 have, for example, a thin plate shape. Furthermore, the third element 23 and the fourth element 24 have, for example, a cylindrical shape. For example, the first element 21, the second element 22, the third element 23, and the fourth element 24 are integrally and continuously formed. With this arrangement, a loop surface LS which is a surface defined by each of the elements is formed. The loop surface LS according to the present embodiment has, for example, a rectangular shape, but the shape of the loop surface LS is not limited to a rectangular shape, and may be a circular shape, an elliptical shape, a polygonal shape, or the like.

As illustrated in FIG. 3C, the length (the length in the X direction) of the first element 21 in a loop of the loop surface LS is set to W1. The second element 22 has a gap GA near the center, and has the entire length set slightly smaller than W1. Furthermore, the lengths (the lengths in the Z direction) of the third element 23 and the fourth element 24 are set to W2. In the present example, the length of each of the first element 21 and the second element 22 in the loop of the loop surface LS is set to be larger than the length of each of the third element 23 and the fourth element 24. Therefore, the height of the antenna device 10A can be reduced.

The loop formed by the first conductor 20 is connected in an alternating current (AC) manner. Here, being connected in the AC manner includes a case where a gap (a gap GA in FIG. 3C) sufficiently smaller than a wavelength is formed in the pattern of the loop, and a case where a DC current does not flow, such as a case where an element such as a capacitor or a varactor is inserted in the loop.

The metal plate 30 is metal having a thin plate shape. The material of the metal plate 30 can include the material of the same material as that of the first conductor 20. However, the material of the metal plate 30 and the material of the first conductor 20 may be different from each other.

The metal plate 30 has a first main surface 31 and a second main surface 32. The first main surface 31 is a surface disposed on the +Z direction side, and the second main surface 32 is a surface disposed on the −Z direction side opposite to the first main surface 31. Note that, in the following description, regarding other constituent elements, a surface disposed on the +Z direction side is referred to as the first main surface, and a surface disposed on the −Z direction side is referred to as the second main surface with respect to other components in some cases. The first main surface 31 extends at least in a direction (the Y direction in the present example) substantially orthogonal to the loop surface LS of the first conductor 20. The first main surface 31 and the second main surface 32 have a rectangular shape in top view. The first main surface 31 and the second main surface 32 of the metal plate 30 have a rectangular outer edge part 33. The outer edge part 33 has a first side portion 33A and a second side portion 33B disposed at positions facing each other in the Y direction, and a third side portion 33C and a fourth side portion 33D disposed at positions facing each other in the X direction. The lengths of the first side portion 33A and the second side portion 33B are set to be larger than the lengths of the third side portion 33C and the fourth side portion 33D.

The first conductor 20 and the metal plate 30 are disposed close to each other. For example, as illustrated in FIG. 3C, the first conductor 20 and the metal plate 30 are disposed such that a space SP is formed between a second main surface 22A of the second element 22 of the first conductor 20 and the first main surface 31. Note that, in FIGS. 3A to 3C, the first conductor 20 is illustrated as floating with respect to the first main surface 31 of the metal plate 30, but the first conductor 20 is supported by a not-illustrated appropriate support member (for example, an insulating support member). This similarly applies to other drawings. The first conductor 20 and the metal plate 30 are electrically insulated from each other.

As illustrated in FIG. 4, in the antenna device 10A, a rectifier circuit 40 is connected to the first conductor 20. For example, both ends of the gap GA of the second element 22 of the first conductor 20 are connected to an input terminal (not illustrated) of the rectifier circuit 40.

The rectifier circuit 40 may be configured as an integrated circuit (IC). As the rectifier circuit 40, a known rectifier circuit can be applied. For example, a bridge circuit, a voltage doubler circuit, a single shunt circuit, or the like can be applied as the rectifier circuit 40. The semiconductor component applied to these rectifier circuits can be optionally selected. The semiconductor component includes, for example, a Schottky barrier diode, a complementary metal oxide semiconductor (CMOS), a high electron mobility transistor (HEMT), or the like.

### (Operation)

An operation example of the antenna device 10A will be described. The first conductor 20 of the antenna device 10A receives electromagnetic wave energy in space. Then, the rectifier circuit 40 converts the received electromagnetic wave energy into a DC voltage and outputs the DC voltage (direct current (DC) output). The DC voltage output from the rectifier circuit 40 is supplied to an appropriate load connected to the rectifier circuit 40.

### (Directional Characteristics)

It has been described that the gain can be improved by disposing the loop antenna such that the loop surface of the loop antenna becomes perpendicular to the metal surface. In the antenna device 10A, the first conductor 20 is disposed such that a magnetic current component penetrating the loop surface LS formed by the first conductor 20 in a cross-sectional view is orthogonal to the first main surface 31 of the metal plate 30.

With this arrangement, the gain of the antenna device 10A can be improved. As illustrated in FIG. 5, in the antenna device 10A having an improved gain, the radiation of the radio wave in a specific direction (for example, in a direction perpendicular to the metal plate 30) has strong directional characteristics.

### (Loop Length and Outer Edge Part)

Although the gain of the antenna device 10A can be improved by the above-described arrangement of the first conductor 20 and the metal plate 30, the gain of the antenna device 10A can be further improved by optimizing the length of the loop (hereinafter, also referred to as a loop length as appropriate) of the first conductor 20 and the minimum length of the outer edge part 33. This point will be described below. Note that, in the present embodiment, the length of the loop of the first conductor 20 is defined by the length of the gap GA (the length in the X direction) from the sum of the lengths of the first element 21, the second element 22, the third element 23, and the fourth element 24. Furthermore, the minimum length of the outer edge part 33 of the metal plate 30 is defined by the length of the third side portion 33C or the fourth side portion 33D.

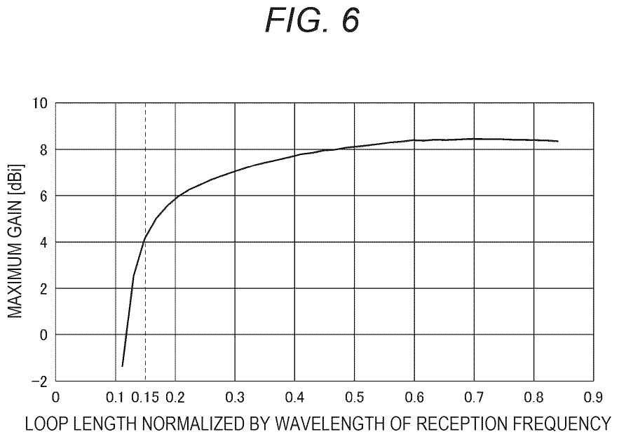

FIG. 6 is a diagram illustrating an example of a simulation result illustrating a relationship between the maximum gain and the loop length. In the simulation result illustrated in FIG. 6, the horizontal axis indicates the length of the loop normalized by the wavelength of the reception frequency, and the vertical axis indicates the maximum gain (dBi). In general, in a case where the maximum gain is larger than 4 dBi, it can be said that the characteristics of the antenna device are good. From this viewpoint, it can be seen that, in a case where the length of the loop normalized by the wavelength of the reception frequency is larger than 0.15, the maximum gain becomes larger than 4 dBi, and the characteristics as an antenna device are good. Furthermore, it can be seen that, in a case where the length of the loop normalized by the wavelength of the reception frequency is larger than 0.2, the maximum gain becomes larger than 6 dBi, and the characteristics as an antenna device are further improved. For example, in a case where the reception frequency of the electromagnetic wave to be received by the antenna device 10A is 2.4 GHz, because the wavelength thereof is about 10 cm, the loop length is set to a value at which the ratio to the wavelength becomes “1.5”. Note that, in a range satisfying the above range, the loop length of the first conductor 20 is set to an appropriate upper limit according to the use of the antenna device, the storage space of the antenna device, and the like.

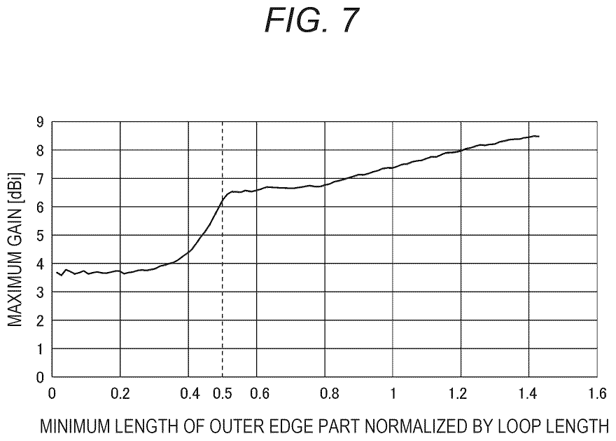

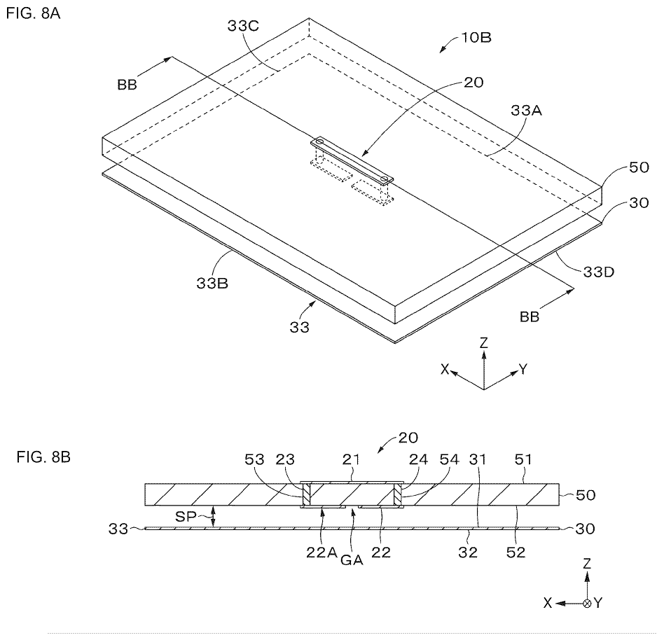

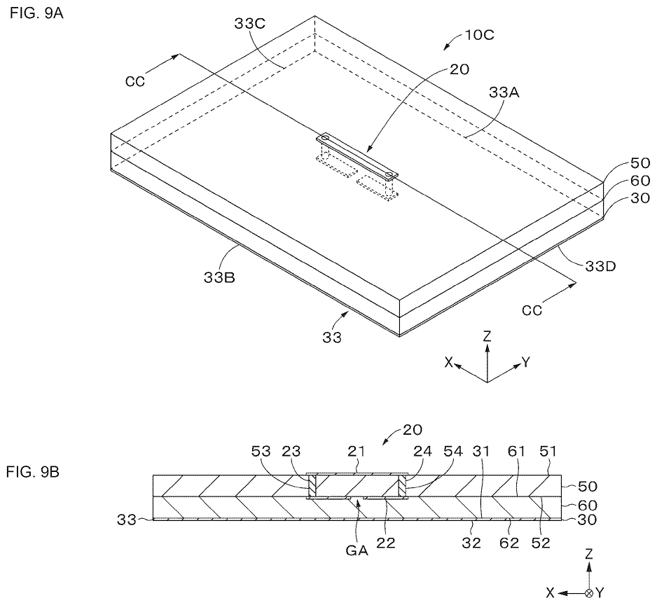

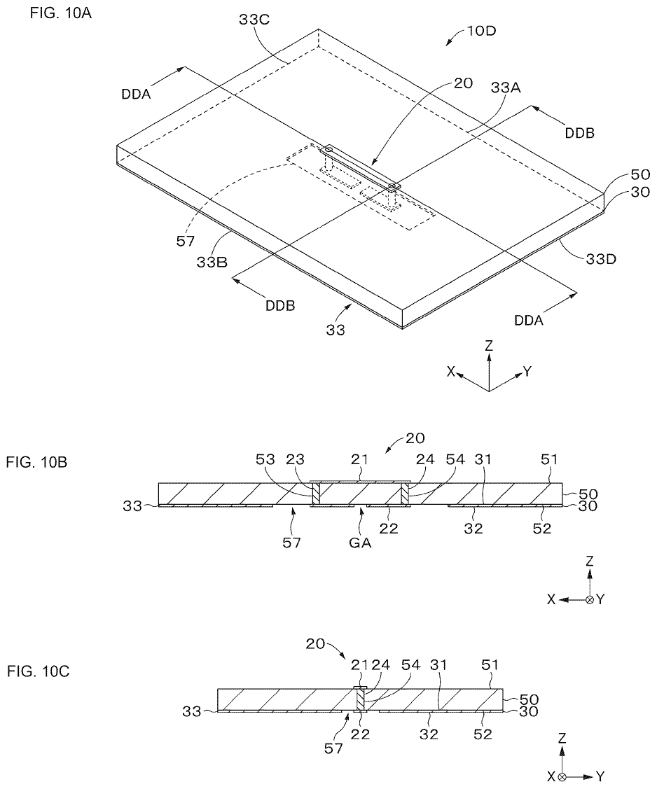

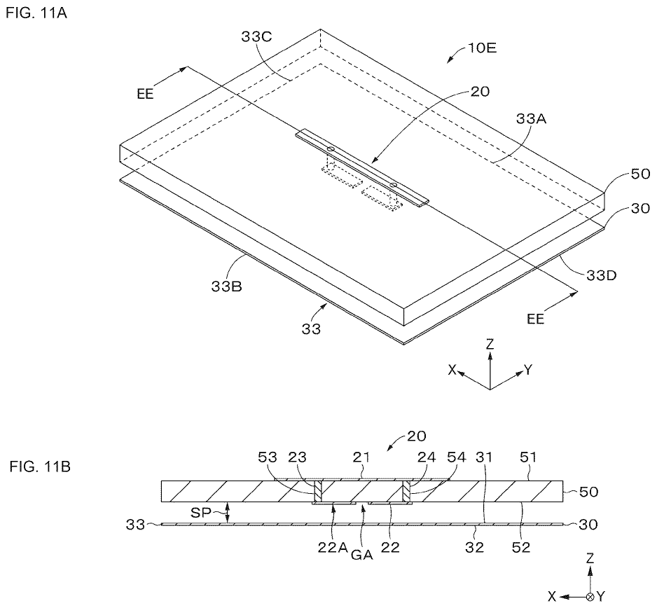

FIG. 7 is a diagram illustrating an example of a simulation result illustrating a relationship between the maximum gain and the size of the metal plate. In the simulation result illustrated in FIG. 7, the horizontal axis indicates the minimum length of the outer edge part of the metal plate normalized by the loop length, and the vertical axis indicates the maximum gain (dBi). As described above, in a case where the maximum gain is larger than 4 dBi, it can be said that the characteristics of the antenna device are good. From this viewpoint, it can be seen that in a case where the minimum length of the outer edge part of the metal plate normalized by the loop length is larger than 0.4 (⅖ of the loop length), the characteristics as an antenna device are good. Furthermore, from this viewpoint, it can be seen that in a case where the minimum length of the outer edge part of the metal plate normalized by the loop length is larger than 0.5 (½ of the loop length), the maximum gain becomes larger than 6 dBi, and the characteristics as an antenna device are further improved. Note that, in a range satisfying the above range, the size of the metal plate is set to an appropriate upper limit according to the use of the antenna device, the storage space of the antenna device, and the like.

From the above, preferably, by making the length of the loop of the first conductor 20 with respect to the wavelength at the reception frequency be larger than 0.15, and the minimum length of the outer edge part 33 of the metal plate 30 with respect to the length of the loop of the first conductor 20 be larger than 0.4, the characteristics of the antenna device can be improved. More preferably, by making the length of the loop of the first conductor 20 with respect to the wavelength at the reception frequency be larger than 0.2, and the minimum length of the outer edge part 33 of the metal plate 30 with respect to the length of the loop of the first conductor 20 be larger than 0.5, the characteristics of the antenna device can be further improved.

### Second Embodiment

Next, a second embodiment will be described. Note that, in the description of the second embodiment, the same or similar configurations in the above description are denoted by the same reference signs, and redundant description will be omitted as appropriate. Furthermore, the matters described in the first embodiment can be applied to the second embodiment unless otherwise specified.

FIG. 8A is a perspective view of an antenna device (an antenna device 10B) according to the second embodiment, and FIG. 8B is a cross-sectional view in a case where the antenna device 10B is cut along a cutting line BB-BB in FIG. 8A.

The antenna device 10B includes a substrate 50. The substrate 50 may be a flexible printed circuit (FPC) or a rigid substrate. At least a part of a first conductor 20 is formed as a metal pattern on the surface of the substrate 50. As illustrated in FIG. 8B, for example, a first element 21 is formed on a first main surface 51 of the substrate 50, and a second element 22 is formed on a second main surface 52 of the substrate 50. Furthermore, a through via 53 and a through via 54 different from the through via 53 are formed in the substrate 50. A third element 23 is disposed in the through via 53, and a fourth element 24 is disposed in the through via 54.

The length of the loop of the first conductor 20 and the minimum length of an outer edge part 33 of a metal plate 30 are set within the same range as in the first embodiment. According to the present embodiment, the effects similar to those of the first embodiment can be obtained. Furthermore, by forming at least a part of the first conductor 20 on the substrate 50 as a metal pattern, the antenna device 10B having a three-dimensional configuration can be easily formed. Furthermore, interference between the first conductor 20 and components and wiring mounted around the substrate 50 can be reduced.

### Third Embodiment

Next, a third embodiment will be described. Note that, in the description of the third embodiment, the same or similar configurations in the above description are denoted by the same reference signs, and redundant description will be omitted as appropriate. Furthermore, the matters described in other embodiments such as the first embodiment can be applied to the present embodiment unless otherwise specified.

FIG. 9A is a perspective view of an antenna device (an antenna device 10C) according to the third embodiment, and FIG. 9B is a cross-sectional view in a case where the antenna device 10C is cut along a cutting line CC-CC in FIG. 9A.

The antenna device 10C according to the present embodiment includes a substrate 50 as in the antenna device 10B. A first element 21 is formed on a first main surface 51 of the substrate 50, and a second element 22 is formed on a second main surface 52 of the substrate 50. Furthermore, a third element 23 is disposed in a through via 53, and a fourth element 24 is disposed in a through via 54.

The antenna device 10C includes a substrate 60 (an example of an other substrate) different from the substrate 50. The substrate 60 has a first main surface 61 and a second main surface 62. As illustrated in FIG. 9B, the substrate 50 and the substrate 60 are stacked such that the first main surface 61 of the substrate 60 is stacked on the second main surface 52 of the substrate 50. Then, a metal plate 30 is formed on the second main surface 62 of substrate 60. The metal plate 30 is formed in a layered manner (as a metal layer) with respect to the second main surface 62.

The length of the loop of a first conductor 20 and the minimum length of an outer edge part 33 of a metal plate 30 are set within the same range as in the first embodiment. According to the present embodiment, the effects similar to those of the first embodiment can be obtained. Furthermore, in the present embodiment, because the antenna device can be manufactured by using a general substrate manufacturing method, the antenna device can be easily manufactured at low cost. Furthermore, because the entire antenna device 10C functioning as a rectenna is included in one substrate, the antenna device 10C can be easily mounted on a device.

Note that, in the present embodiment, the two-layer multilayer substrate (the substrate 50 and the substrate 60) has been described as an example, but a multilayer substrate of three or more layers may be used.

### Fourth Embodiment

Next, a fourth embodiment will be described. Note that, in the description of the fourth embodiment, the same or similar configurations in the above description are denoted by the same reference signs, and redundant description will be omitted as appropriate. Furthermore, the matters described in other embodiments such as the first embodiment can be applied to the present embodiment unless otherwise specified.

FIG. 10A is a perspective view of an antenna device (an antenna device 10D) according to the fourth embodiment, FIG. 10B is a cross-sectional view in a case where the antenna device 10D is cut along a cutting line DDA-DDA in FIG. 10A, and FIG. 10C is a cross-sectional view in a case where the antenna device 10D is cut along a cutting line DDB-DDB in FIG. 10A.

The antenna device 10D according to the present embodiment includes a substrate 50 as in the antenna device 10B. A first element 21 is formed on a first main surface 51 of the substrate 50, and a second element 22 is formed on a second main surface 52 of the substrate 50. Furthermore, a third element 23 is disposed in a through via 53, and a fourth element 24 is disposed in a through via 54.

On the second main surface 52 of the substrate 50, a metal plate 30 is formed by using the same metal layer as the second element 22. Furthermore, on the second main surface 52, a removed part 57 from which the metal layer is partially removed is formed in order to electrically insulate the second element 22 and the metal plate 30 from each other. The second main surface 52 of the substrate 50 is exposed from the portion of the removed part 57.

The length of the loop of a first conductor 20 and the minimum length of an outer edge part 33 of a metal plate 30 are set within the same range as in the first embodiment. According to the present embodiment, the effects similar to those of the first embodiment can be obtained. Furthermore, in the present embodiment, because the antenna device can be manufactured by using a general substrate manufacturing method, the antenna device can be easily manufactured at low cost. Moreover, according to the present embodiment, because the metal plate 30 can be formed without forming a multilayer substrate, the height of the antenna device 10D can be reduced.

### Fifth Embodiment

Next, a fifth embodiment will be described. Note that, in the description of the fifth embodiment, the same or similar configurations in the above description are denoted by the same reference signs, and redundant description will be omitted as appropriate. Furthermore, the matters described in other embodiments such as the first embodiment can be applied to the present embodiment unless otherwise specified.

FIG. 11A is a perspective view of an antenna device (an antenna device 10E) according to the fifth embodiment, and FIG. 11B is a cross-sectional view in a case where the antenna device 10E is cut along a cutting line EE-EE in FIG. 11A.

The antenna device 10E according to the present embodiment includes a substrate 50 as in the antenna device 10B. A first element 21 is formed on a first main surface 51 of the substrate 50, and a second element 22 is formed on a second main surface 52 of the substrate 50. Furthermore, a third element 23 is disposed in a through via 53, and a fourth element 24 is disposed in a through via 54.

Furthermore, from the viewpoint of the distance to a metal plate 30 in the thickness direction (the Z direction) of the substrate 50, the first element 21 is disposed at a position where the distance to the metal plate 30 is larger than the distance thereto from the second element 22, that is, closer to the +Z direction (the upper side).

The present embodiment exemplifies an embodiment in which the area of the first element 21 is larger than the area of the second element 22. For example, in a case where each of the first element 21 and the second element 22 has a rectangular shape, the lengths in the transverse direction (the lengths in the Y direction) of the first element 21 and the second element 22 are the same, and the length in the longitudinal direction (the length in the X direction) of the first element 21 is set to be larger than the length in the longitudinal direction (a length excluding the length in the X direction of a gap GA) of the second element 22. As an example, the length of the first element 21 in the longitudinal direction is set in a range of 1.4 to 2 times (preferably about 1.6 times) the length of the second element 22 in the longitudinal direction.

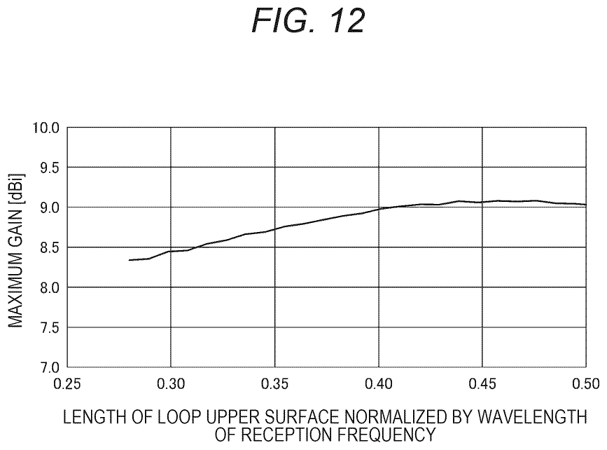

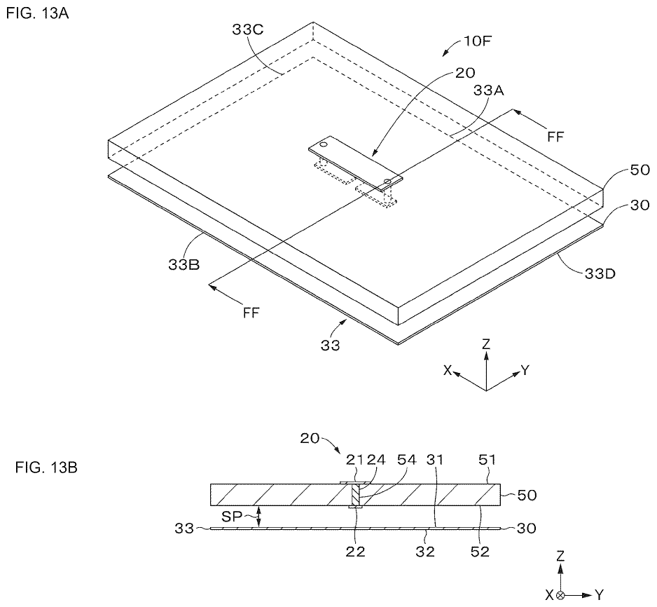

FIG. 12 is a simulation result illustrating a relationship between the maximum gain and the length of the loop upper surface (here, the length of the first element 21 in the X direction). In the simulation result illustrated in FIG. 12, the horizontal axis indicates the length of the loop upper surface normalized by the wavelength of the reception frequency, and the vertical axis indicates the maximum gain (dBi). As illustrated in FIG. 12, the maximum gain is improved by increasing the length of the loop upper surface normalized by the wavelength of the reception frequency. This is because the electromagnetic wave in the air can be efficiently received by increasing the area of the first element 21 to allow the electric current flowing through a first conductor 20 to be increased, and with this arrangement, the magnetic current component penetrating a loop surface LS can be increased. That is, according to the configuration of the antenna device 10E, an effect similar to the effect described in the first embodiment can be obtained, and moreover, an effect of improving the required gain at a high frequency can be obtained more greatly.

### Sixth Embodiment

Next, a sixth embodiment will be described. Note that, in the description of the sixth embodiment, the same or similar configurations in the above description are denoted by the same reference signs, and redundant description will be omitted as appropriate. Furthermore, the matters described in other embodiments such as the first embodiment can be applied to the present embodiment unless otherwise specified.

FIG. 13A is a perspective view of an antenna device (an antenna device 10F) according to the sixth embodiment, and FIG. 13B is a cross-sectional view in a case where the antenna device 10F is cut along a cutting line FF-FF in FIG. 13A.

The present embodiment also exemplifies an embodiment in which the area of a first element 21 is larger than the area of a second element 22. For example, in a case where each of the first element 21 and the second element 22 has a rectangular shape, the lengths in the longitudinal direction of the first element 21 and the second element 22 (The lengths in the X direction. However, the length of the second element 22 in the X direction in the present example includes the length of a gap GA in the X direction.) are the same, and the length of the first element 21 in the transverse direction (the length in the Y direction) is set to be larger than the length of the second element 22 in the transverse direction. As an example, the length of the first element 21 in the transverse direction is set in a range of 1.2 to 3 times the length of the second element 22 in the transverse direction.

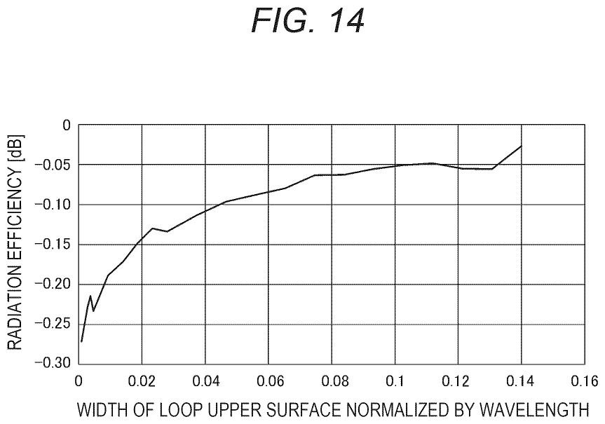

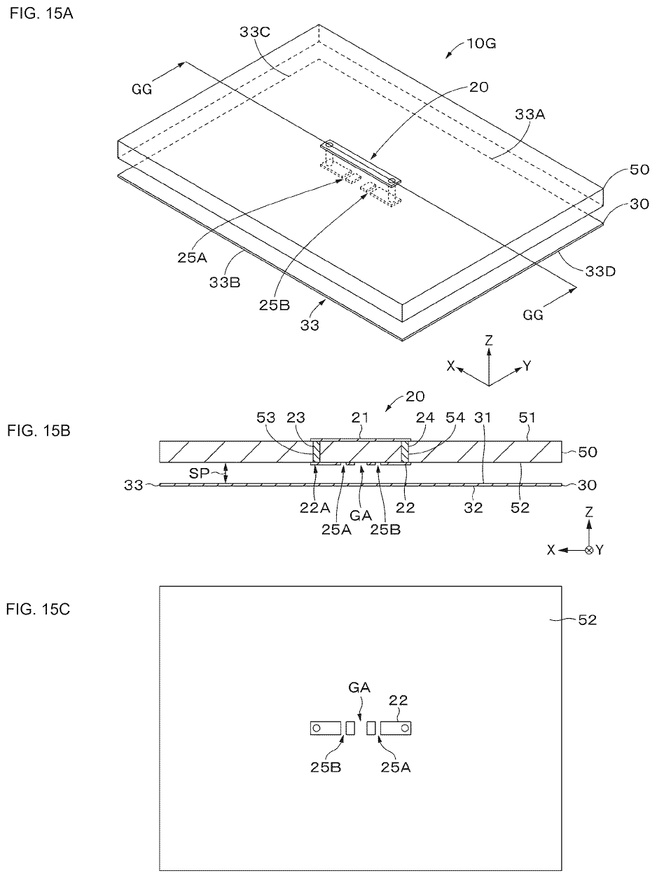

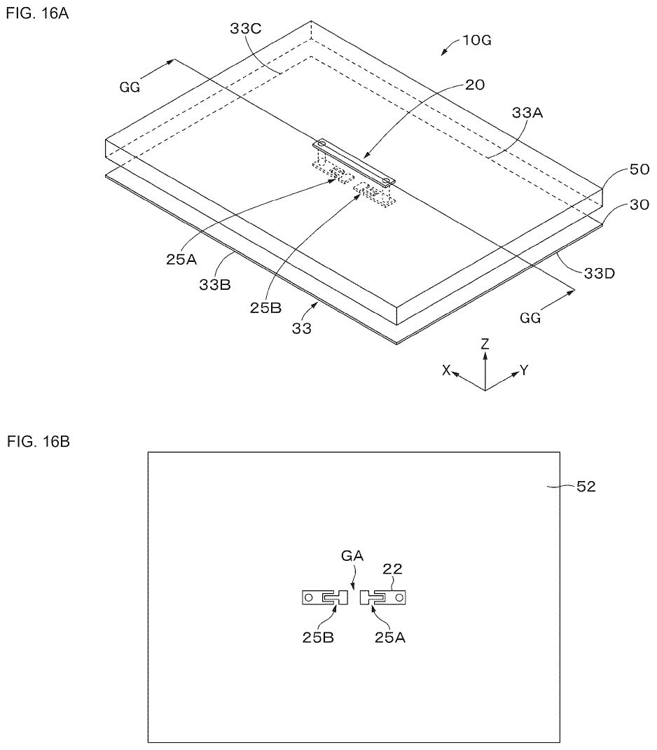

FIG. 14 is a simulation result illustrating a relationship between the radiation efficiency and the width of the loop upper surface (the length in the Y direction). In the simulation result illustrated in FIG. 14, the horizontal axis indicates the width of the loop upper surface normalized by the wavelength of the reception frequency, and the vertical axis indicates the radiation efficiency (dB). As illustrated in FIG. 14, the radiation efficiency is improved by increasing the width of the loop upper surface normalized by the wavelength of the reception frequency. For example, because very good efficiency is required from the viewpoint of power transmission, it is not preferable that the radiation efficiency is lower than about −0.10 dB. That is, the width of the loop upper surface normalized by the wavelength is preferably about 0.04 or more. According to the configuration of the antenna device 10F described above, an effect similar to the effect described in the first embodiment can be obtained, and moreover, the radiation efficiency can be improved.

### Seventh Embodiment

Next, a seventh embodiment will be described. Note that, in the description of the seventh embodiment, the same or similar configurations in the above description are denoted by the same reference signs, and redundant description will be omitted as appropriate. Furthermore, the matters described in other embodiments such as the first embodiment can be applied to the present embodiment unless otherwise specified.

FIG. 15A is a perspective view of an antenna device (an antenna device 10G) according to the seventh embodiment, and FIG. 15B is a cross-sectional view in a case where the antenna device 10G is cut along a cutting line GG-GG in FIG. 15A. Furthermore, FIG. 15C is a view of a substrate 50 included in the antenna device 10G as viewed from the second main surface 52 side.

The antenna device 10G according to the present embodiment includes the substrate 50 as in the antenna device 10B. A first element 21 is formed on a first main surface 51 of the substrate 50, and a second element 22 is formed on a second main surface 52 of the substrate 50. Furthermore, a third element 23 is disposed in a through via 53, and a fourth element 24 is disposed in a through via 54.

In the present embodiment, an absent portion which is a slight space is formed in the loop of a first conductor 20. For example, as illustrated in FIG. 15C, two absent portions 25A and 25B are formed in the second element 22. The absent portion 25A and the absent portion 25B can be formed by partially removing the second element 22. The absent portion 25A and the absent portion 25B each have, for example, a linear shape extending in the Y direction.

The length of the loop of a first conductor 20 and the minimum length of an outer edge part 33 of a metal plate 30 are set within the same range as in the first embodiment. According to the present embodiment, the effects similar to those of the first embodiment can be obtained. Furthermore, by providing the absent portion 25A and the absent portion 25B, the DC current can be prevented from flowing through the entire loop of the first conductor 20 to cause a short circuit (However, in terms of high frequency, an electric current flows across the absent portions 25A and 25B.). Furthermore, the absent portion has a function of matching impedance. Note that, by reducing the areas of the absent portions 25A and 25B as much as possible to maintain sufficient electrical connection, reduction in the radiation efficiency and the gain is only limited.

Note that the shapes of the absent portion 25A and the absent portion 25B are not limited to a linear shape. For example, as illustrated in FIGS. 16A and 16B, the shape of each of the absent portion 25A and the absent portion 25B may be a comb shape (a structure in which a recession and a protrusion are substantially alternately arranged). By forming the shape of the absent portion 25A and the absent portion 25B into a comb shape, the process of forming the absent portion can be facilitated, and also, the AC connection can be strengthened.

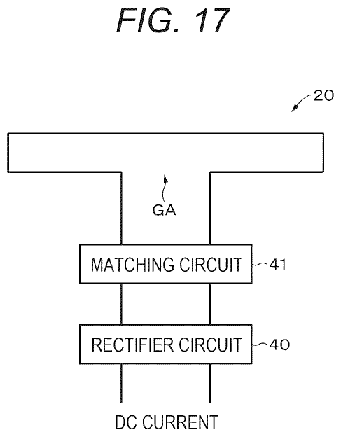

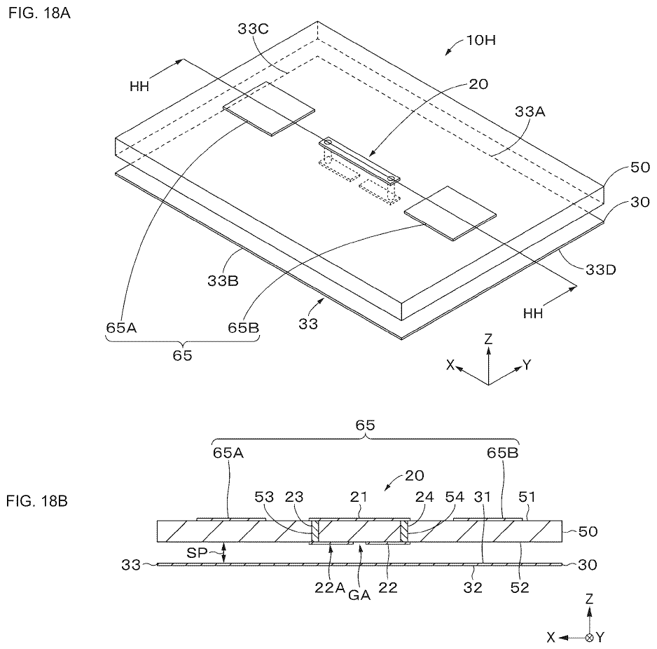

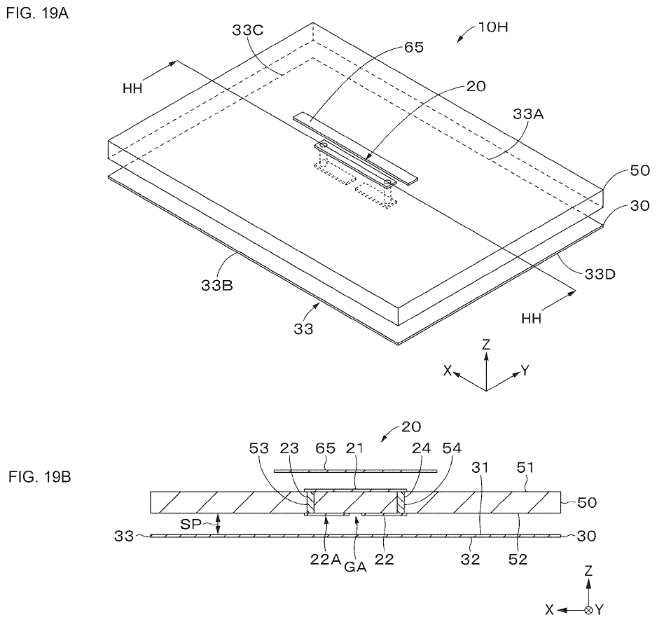

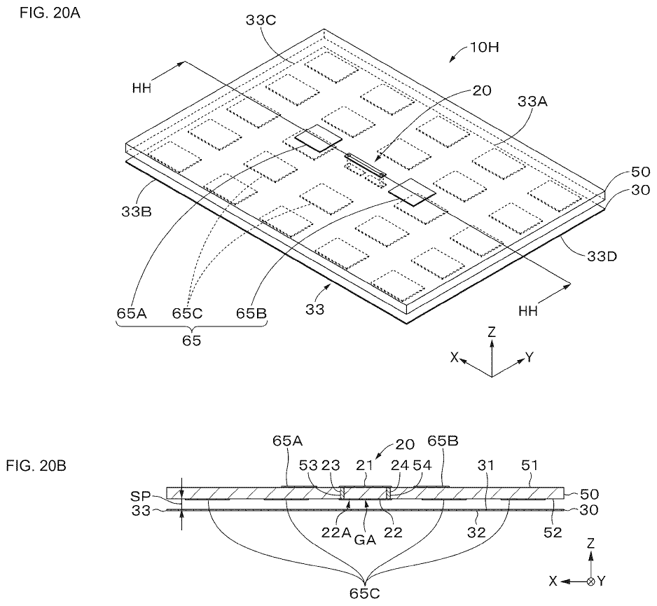

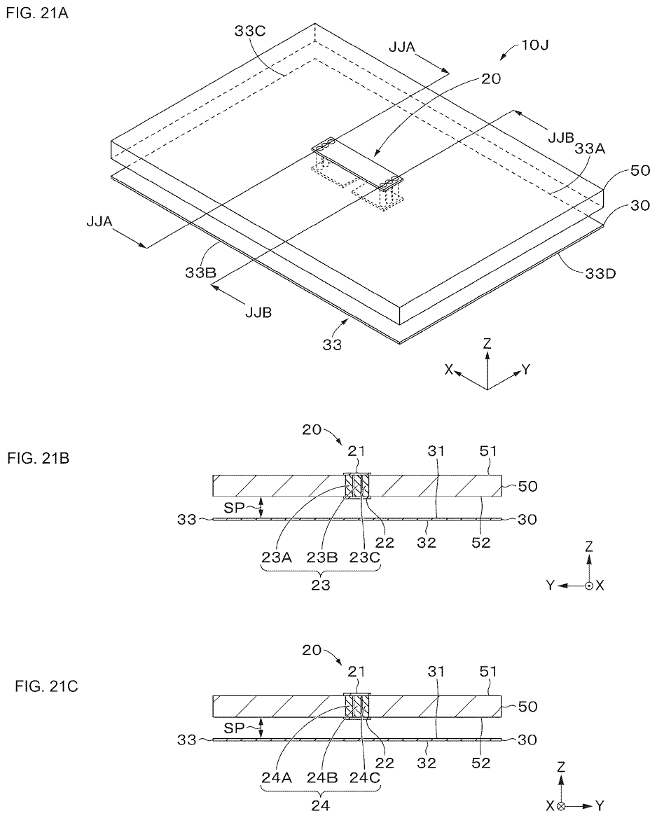

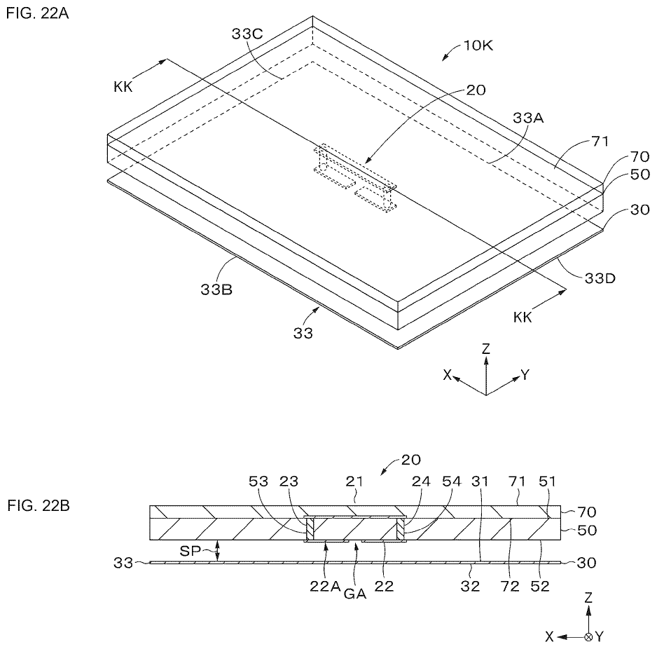

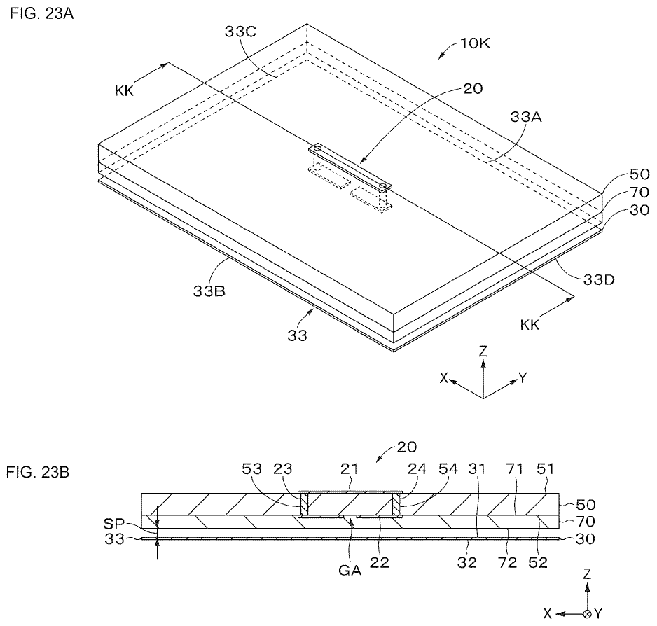

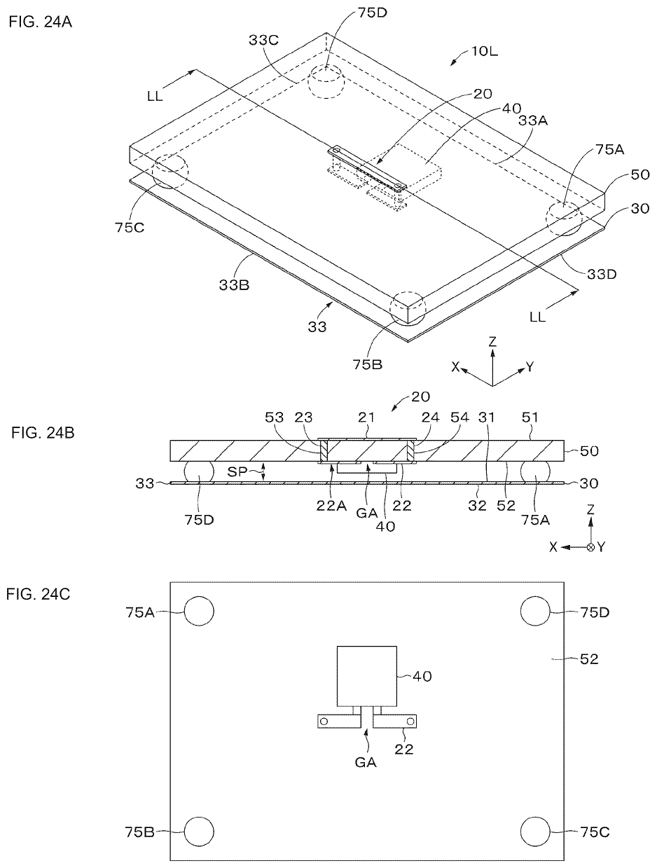

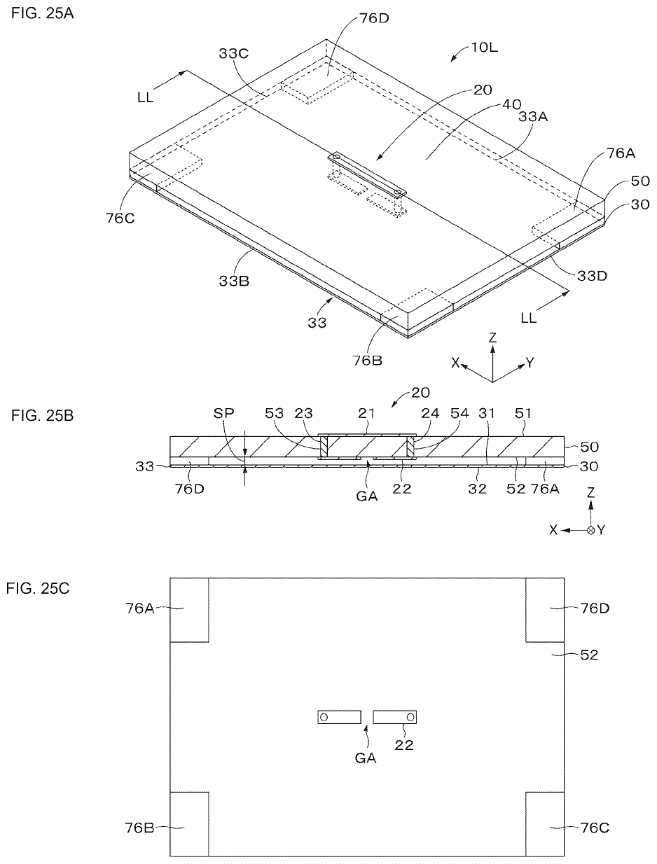

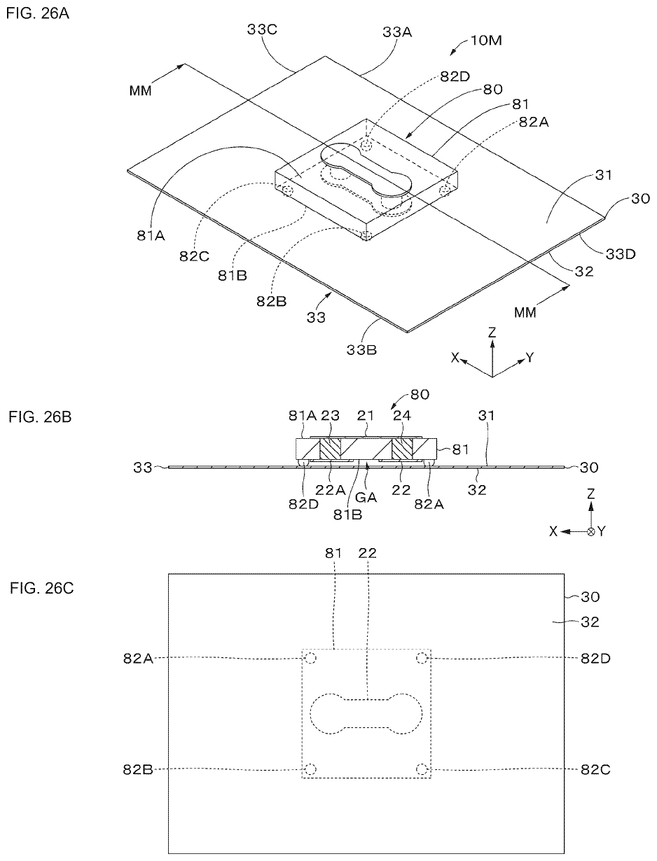

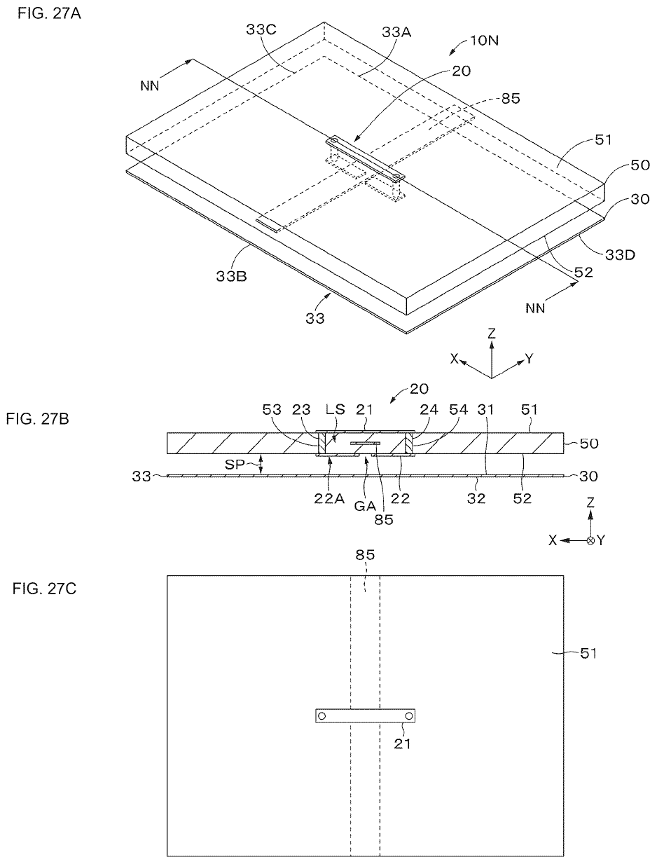

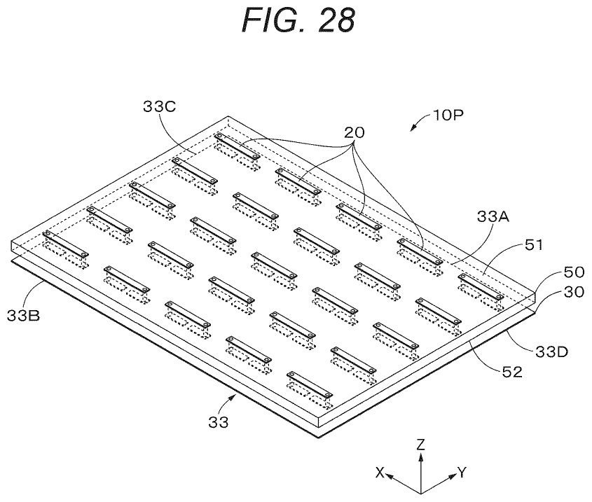

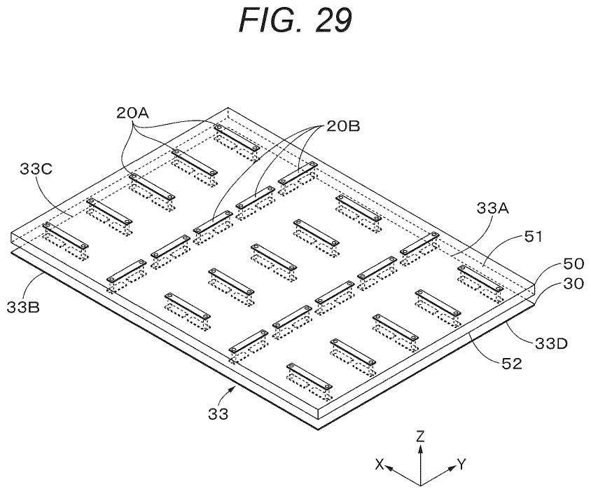

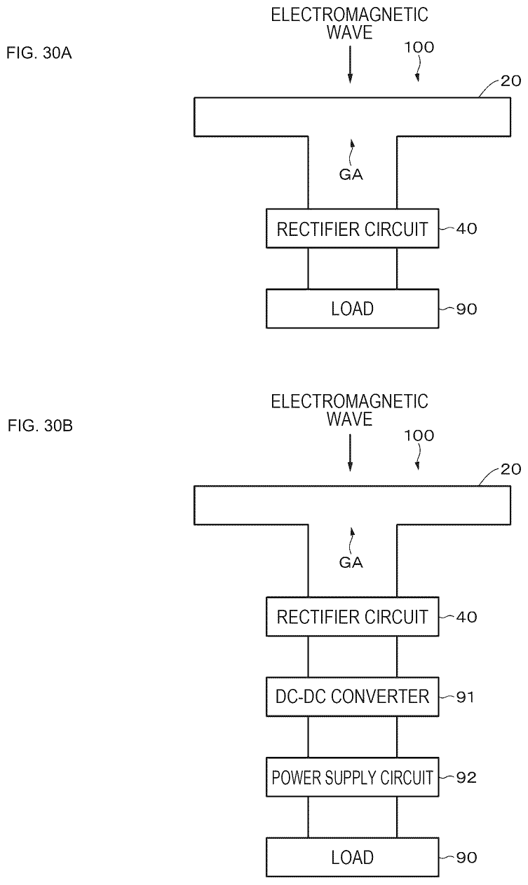

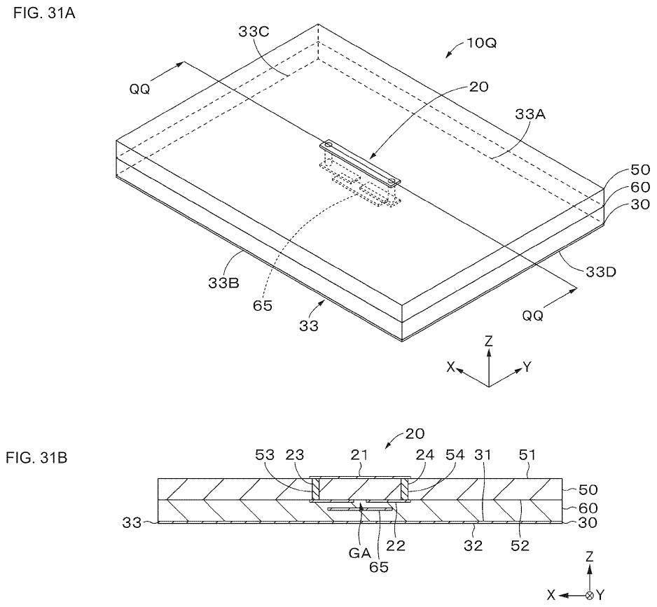

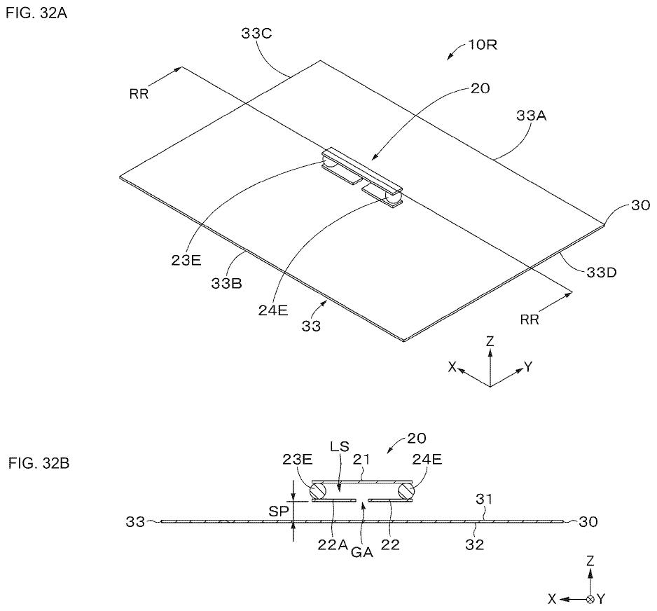

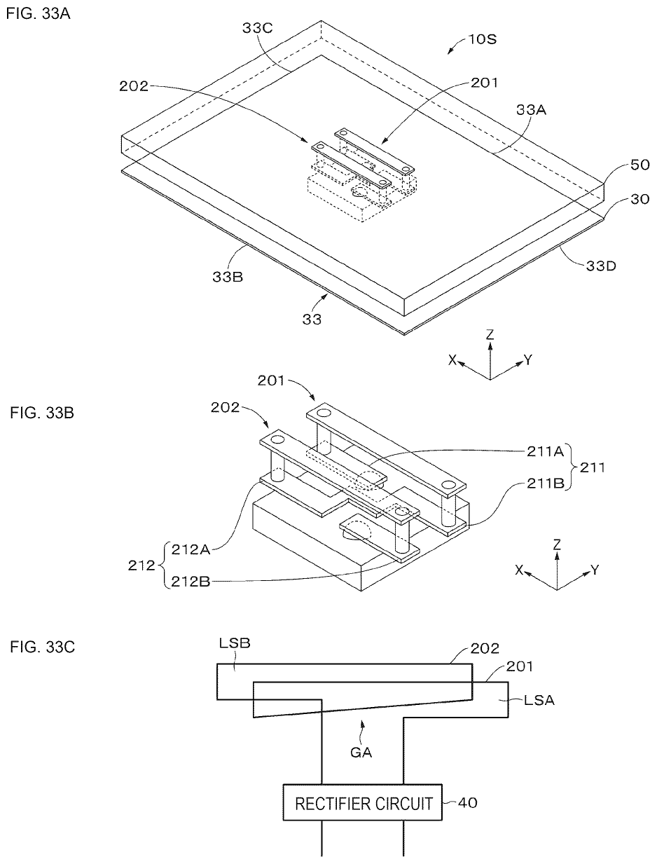

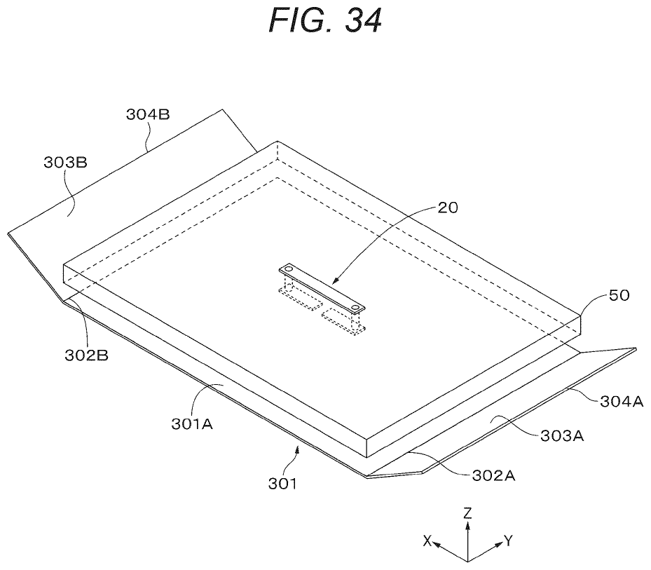

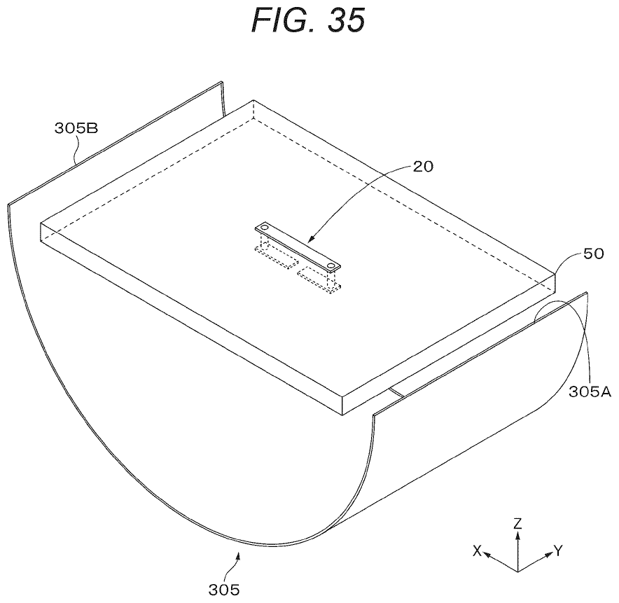

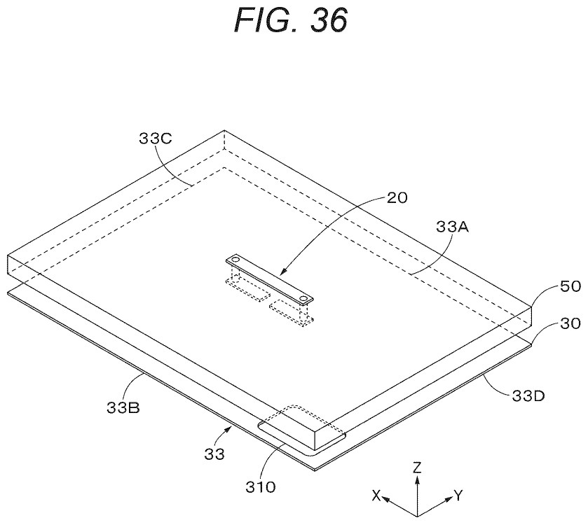

Furthermore, from the viewpoint of preventing the DC current from being reflected by the loop of the first conductor 20, as illustrated in FIG. 17, a matching circuit 41 for impedance matching may be connected between the first conductor 20 and a rectifier circuit 40. That is, in the present technology, connection of the rectifier circuit 40 to the first conductor 20 means that the rectifier circuit 40 may be directly electrically connected to the first conductor 20, or the rectifier circuit 40 may be connected via another circuit.

### Eighth Embodiment

Next, an eighth embodiment will be described. Note that, in the description of the eighth embodiment, the same or similar configurations in the above description are denoted by the same reference signs, and redundant description will be omitted as appropriate. Furthermore, the matters described in other embodiments such as the first embodiment can be applied to the present embodiment unless otherwise specified.

FIG. 18A is a perspective view of an antenna device (an antenna device 10H) according to the eighth embodiment, and FIG. 18B is a cross-sectional view in a case where the antenna device 10H is cut along a cutting line HH-HH in FIG. 18A.

The antenna device 10H according to the present embodiment includes a substrate 50 as in the antenna device 10B. A first element 21 is formed on a first main surface 51 of the substrate 50, and a second element 22 is formed on a second main surface 52 of the substrate 50. Furthermore, a third element 23 is disposed in a through via 53, and a fourth element 24 is disposed in a through via 54.

The antenna device 10H according to the present embodiment includes a metal pattern 65 separated from a first conductor 20 in terms of direct current. The metal pattern 65 includes, for example, two metal patterns 65A and 65B. The two metal patterns 65A and 65B are formed, for example, on the same surface as the first main surface 51 of the substrate 50 on which the first conductor 20 (specifically, the first element 21) is formed. The two metal patterns 65A and 65B are provided, for example, at left and right positions with respect to the first conductor 20 in the X direction. The metal pattern 65 has, for example, a rectangular shape. The thickness of the metal pattern 65 is not particularly limited, but is, for example, substantially the same as the thickness of the first element 21.

The length of the loop of a first conductor 20 and the minimum length of an outer edge part 33 of a metal plate 30 are set within the same range as in the first embodiment. According to the present embodiment, the effects similar to those of the first embodiment can be obtained. Furthermore, even in a case of not being electrically connected to the first conductor 20, the antenna device 10H can have the gain improved, for example, at a high frequency by disposing the metal pattern 65 around a loop surface LS of the first conductor 20.

The position of forming the metal pattern 65 is not limited to the first main surface 51 of the substrate 50. For example, as illustrated in FIG. 19, the metal pattern 65 may be disposed above (in the +Z direction) the first conductor 20. The metal pattern 65 illustrated in FIG. 19 has, for example, a rectangular shape having the longitudinal direction in the X direction and the transverse direction in the Y direction. Note that, in the case of the configuration illustrated in FIG. 19, the metal pattern 65 is supported by, for example, an appropriate support member (not illustrated) provided on the first main surface 51.

Furthermore, as illustrated in FIG. 20, the two metal patterns (the metal patterns 65A, 65B) may be formed on the first main surface 51 of the substrate 50, and moreover, the metal patterns (metal patterns 65C) may also be formed on the second main surface 52 of the substrate 50 on which the second element 22 is formed. Also with these configurations, the gain of the antenna device 10H can be improved.

Note that the shapes of the metal patterns 65A, 65B, and 65C may not be rectangular, and may be any shape such as a circular shape, an elliptical shape, and a polygonal shape.

Furthermore, the number of the metal patterns 65 can be appropriately changed. Furthermore, the number of the metal patterns formed on each of the first main surface 51 and the second main surface 52 of the substrate 50 may be the same as or different from each other. The metal pattern may constitute a metamaterial.

### Ninth Embodiment

Next, a ninth embodiment will be described. Note that, in the description of the ninth embodiment, the same or similar configurations in the above description are denoted by the same reference signs, and redundant description will be omitted as appropriate. Furthermore, the matters described in other embodiments such as the first embodiment can be applied to the present embodiment unless otherwise specified.

FIG. 21A is a perspective view of an antenna device (an antenna device 10J) according to the ninth embodiment, FIG. 21B is a cross-sectional view in a case where the antenna device 10J is cut along a cutting line JJA-JJA in FIG. 21A, and FIG. 21C is a cross-sectional view in a case where the antenna device 10J is cut along a cutting line JJB-JJB in FIG. 21A.

The antenna device 10J according to the present embodiment includes a substrate 50 as in the antenna device 10B. A first element 21 is formed on a first main surface 51 of the substrate 50, and a second element 22 is formed on a second main surface 52 of the substrate 50.

Furthermore, the antenna device 10J according to the present embodiment includes a plurality of third elements and a plurality of fourth elements. As illustrated in FIG. 21B, the antenna device 10J includes, for example, three third elements (a third element 23A, a third element 23B, and a third element 23C). Furthermore, as illustrated in FIG. 21C, the antenna device 10J includes, for example, three fourth elements (a fourth element 24A, a fourth element 24B, and a fourth element 24C).

Six through vias are formed in the substrate 50. Then, the three third elements and the three fourth elements are respectively disposed for different through vias. The ends of the third element 23A, the third element 23B, and the third element 23C are each connected to the first element 21 and the second element 22. Similarly, the ends of the fourth element 24A, the fourth element 24B, and the fourth element 24C are each connected to the first element 21 and the second element 22.

The length of the loop of a first conductor 20 and the minimum length of an outer edge part 33 of a metal plate 30 are set within the same range as in the first embodiment. According to the present embodiment, the effects similar to those of the first embodiment can be obtained. Furthermore, by disposing each of the plurality of third elements and the plurality of fourth elements in corresponding one of the plurality of through vias to form a loop, the conductivity of the first conductor 20 is increased, and the efficiency and the gain of the antenna device 10J can be improved. Note that the number of the third elements and the number of the fourth elements may be the same as or different from each other as described above.

### Tenth Embodiment

Next, a tenth embodiment will be described. Note that, in the description of the tenth embodiment, the same or similar configurations in the above description are denoted by the same reference signs, and redundant description will be omitted as appropriate. Furthermore, the matters described in other embodiments such as the first embodiment can be applied to the present embodiment unless otherwise specified.

FIG. 22A is a perspective view of an antenna device (an antenna device 10K) according to the tenth embodiment, and FIG. 22B is a cross-sectional view in a case where the antenna device 10K is cut along a cutting line KK-KK in FIG. 22A.

The antenna device 10K according to the present embodiment includes a substrate 50 as in the antenna device 10B. A first element 21 is formed on a first main surface 51 of the substrate 50, and a second element 22 is formed on a second main surface 52 of the substrate 50. Furthermore, a third element 23 is disposed in a through via 53, and a fourth element 24 is disposed in a through via 54.

The antenna device 10K includes a heat dissipation member 70. The heat dissipation member 70 is, for example, connected to be stacked on the upper side of the substrate 50. For example, as illustrated in FIG. 22B, the heat dissipation member 70 has a first main surface 71 and a second main surface 72, and is stacked on the substrate 50 such that the second main surface 72 is in contact with the first main surface 51 of the substrate 50.

As the heat dissipation member 70, metal such as copper or aluminum, graphite, ceramics, or the like can be used. The size of the heat dissipation member 70 may be the same as that of the substrate 50, or may be larger or smaller than that of the substrate 50. Furthermore, the heat dissipation member 70 can be shaped into an appropriate shape, and the heat dissipation member 70 can also have a thickness appropriately set on the basis of the shape and size of the antenna device 10K.

The length of the loop of a first conductor 20 and the minimum length of an outer edge part 33 of a metal plate 30 are set within the same range as in the first embodiment. According to the present embodiment, the effects similar to those of the first embodiment can be obtained. Furthermore, by providing the heat dissipation member 70, heat generated by the antenna device 10K and heat generated by surrounding ICs and the like can be effectively released. In particular, because relatively large power is transmitted in a high frequency band such as a millimeter wave band, it is assumed that the heat generation increases, but the presence of the heat dissipation member 70 can reduce the influence of the heat generation.

Note that, as illustrated in FIGS. 23A and 23B, the heat dissipation member 70 may be stacked on the lower side of the substrate 50. That is, the heat dissipation member 70 may be stacked on the substrate 50 such that the second main surface 52 of the substrate 50 and the first main surface 71 of the heat dissipation member 70 are in contact with each other.

Furthermore, in the configuration illustrated in FIGS. 22A and 22B described above, the first element 21 may be formed on the first main surface 71 of the heat dissipation member 70. In this case, the third element 23 and the fourth element 24 are further extended upward and are connected to the first element 21 formed on the first main surface 71. Furthermore, in the configuration illustrated in FIGS. 23A and 23B, the second element 22 may be formed on the second main surface 72 of the heat dissipation member 70. In this case, the third element 23 and the fourth element 24 are further extended downward and are connected to the second element 22 formed on the second main surface 72.

### Eleventh Embodiment

Next, an eleventh embodiment will be described. Note that, in the description of the eleventh embodiment, the same or similar configurations in the above description are denoted by the same reference signs, and redundant description will be omitted as appropriate. Furthermore, the matters described in other embodiments such as the first embodiment can be applied to the present embodiment unless otherwise specified.

FIG. 24A is a perspective view of an antenna device (an antenna device 10L) according to the eleventh embodiment, and FIG. 24B is a cross-sectional view in a case where the antenna device 10L is cut along a cutting line LL-LL in FIG. 24A.

Furthermore, FIG. 24C is a view of a substrate 50 included in the antenna device 10L as viewed from a second main surface 52.

The antenna device 10L according to the present embodiment includes the substrate 50 as in the antenna device 10B. A first element 21 is formed on a first main surface 51 of the substrate 50, and a second element 22 is formed on the second main surface 52 of the substrate 50. Furthermore, a third element 23 is disposed in a through via 53, and a fourth element 24 is disposed in a through via 54.

The antenna device 10L further includes a fixing part for fixing the substrate 50 and a metal plate 30. The fixing part according to the present embodiment includes, for example, four fixing parts (fixing parts 75A, 75B, 75C, and 75D). Note that, in a case where it is not necessary to distinguish the individual fixing parts, the fixing parts are appropriately collectively referred to as the fixing parts 75. The fixing part 75 is, for example, a spherical solder bump. In the present embodiment, the substrate 50 and the metal plate 30 are fixed by using the solder bumps. Each of the four fixing parts 75 is provided near each of the four corners. When the substrate 50 and the metal plate 30 are fixed by the fixing parts 75, a space SP (an example of a space part) corresponding to the thickness of the fixing part 75 is formed between the second main surface 52 of the substrate 50 and a first main surface 31 of the metal plate 30. A rectifier circuit 40 is disposed in this space SP.

The rectifier circuit 40 disposed in the space SP is connected to the second element 22 of a first conductor 20.

Note that the fixing part is not limited to the solder bump. The fixing part may be a solder paste. For example, as illustrated in FIGS. 25A, 25B, and 25C, solder pastes 76A, 76B, 76C, and 76D are applied near the four corners between the substrate 50 and the metal plate 30. By each of the solder pastes being solidified, the substrate 50 and the metal plate 30 are fixed.

Note that, although not illustrated in FIGS. 25A, 25B, and 25C, the rectifier circuit 40 may be disposed in the space SP formed by the substrate 50 and the metal plate 30 being fixed with the solder pastes near the four corners. Furthermore, the positions where the solder bumps are formed and the positions where the solder pastes are applied are not limited to the four corners and can be set to appropriate positions. Furthermore, the fixing part may be a bonding material or an adhesive material.

The length of the loop of the first conductor 20 and the minimum length of an outer edge part 33 of the metal plate 30 are set within the same range as in the first embodiment.

According to the present embodiment, the effects similar to those of the first embodiment can be obtained. Furthermore, because the substrate 50 and the metal plate 30 are fixed by solder bumps, metal pastes, or the like, a process of forming the substrate and the metal plate integrally with a semiconductor can be utilized, and the antenna device 10L can be easily manufactured by a normal substrate process. As an example, the configuration of the antenna device 10L according to the present embodiment is a configuration that can be applied in a case where the reception frequency is in a 28 GHZ band.

### Twelfth Embodiment

Next, a twelfth embodiment will be described. Note that, in the description of the twelfth embodiment, the same or similar configurations in the above description are denoted by the same reference signs, and redundant description will be omitted as appropriate. Furthermore, the matters described in other embodiments such as the first embodiment can be applied to the present embodiment unless otherwise specified.

FIG. 26A is a perspective view of an antenna device (an antenna device 10M) according to the twelfth embodiment, and FIG. 26B is a cross-sectional view in a case where the antenna device 10M is cut along a cutting line MM-MM in FIG. 26A. Furthermore, FIG. 26C is a view of a metal plate 30 included in the antenna device 10M as viewed from a second main surface 32. Note that, in FIG. 26C, constituent elements on the first main surface 31 side are indicated by broken lines.

The antenna device 10M includes a rectifier IC 80. The rectifier IC 80 has, for example, a housing 81 having a box shape, and a rectifier circuit (not illustrated) is housed in the housing 81. The housing 81 is formed by using an insulating member such as resin. The housing 81 is fixed to the metal plate 30. For example, solder bumps 82A, 82B, 82C, and 82D are formed near four corners of the housing 81, and the housing 81 is connected to the metal plate 30 by these solder bumps.

A part of a first conductor 20 is formed on the surface of the housing 81. For example, a first element 21 of the first conductor 20 is formed on a first main surface 81A of the housing 81, and a second element 22 of the first conductor 20 is formed on a second main surface 81B of the housing 81. A third element 23 and a fourth element 24 are each disposed, for example, in a hole penetrating the housing 81 (for example, a semiconductor in the housing 81). The third element 23 and the fourth element 24 may be formed on the side surface of the housing 81.

The length of the loop of the first conductor 20 and the minimum length of an outer edge part 33 of the metal plate 30 are set within the same range as in the first embodiment.

According to the present embodiment, the effects similar to those of the first embodiment can be obtained. As an example, the configuration of the antenna device 10M according to the present embodiment is a configuration that can be applied in a case where the reception frequency is in a 60 GHz band.

### Thirteenth embodiment

Next, a thirteenth embodiment will be described. Note that, in the description of the thirteenth embodiment, the same or similar configurations in the above description are denoted by the same reference signs, and redundant description will be omitted as appropriate. Furthermore, the matters described in other embodiments such as the first embodiment can be applied to the present embodiment unless otherwise specified.

FIG. 27A is a perspective view of an antenna device (an antenna device 10N) according to the thirteenth embodiment, and FIG. 27B is a cross-sectional view in a case where the antenna device 10N is cut along a cutting line NN-NN in FIG. 27A.

Furthermore, FIG. 27C is a view of a substrate 50 included in the antenna device 10N as viewed from the first main surface 51 side.

The antenna device 10N according to the present embodiment includes the substrate 50 as in the antenna device 10B. A first element 21 is formed on the first main surface 51 of the substrate 50, and a second element 22 is formed on a second main surface 52 of the substrate 50. Furthermore, a third element 23 is disposed in a through via 53, and a fourth element 24 is disposed in a through via 54.

The antenna device 10N includes a conductor part 85 (an example of a third conductor) provided inside the substrate 50. The conductor part 85 is, for example, conductive metal and has a thin plate shape. As illustrated in FIGS. 27A, 27B, and 27C, the conductor part 85 is provided so as to penetrate a loop surface LS of a first conductor 20.

The length of the loop of the first conductor 20 and the minimum length of an outer edge part 33 of a metal plate 30 are set within the same range as in the first embodiment. According to the present embodiment, the effects similar to those of the first embodiment can be obtained. Furthermore, because the conductor part 85 penetrates the loop surface LS, the gain of the antenna device 10N can be improved.

Note that the shape and the size of the conductor part 85 can be appropriately changed as long as the conductor part penetrates the loop surface LS.

### Fourteenth Embodiment

Next, a fourteenth embodiment will be described. Note that, in the description of the fourteenth embodiment, the same or similar configurations in the above description are denoted by the same reference signs, and redundant description will be omitted as appropriate. Furthermore, the matters described in other embodiments such as the first embodiment can be applied to the present embodiment unless otherwise specified.

FIG. 28 is a perspective view of an antenna device (an antenna device 10P) according to the fourteenth embodiment. The antenna device 10P has a configuration substantially similar to that of the antenna device 10B (see FIG. 8) according to the second embodiment, but is different in including a plurality of first conductors 20.

The plurality of first conductors 20 is arranged in, for example, an array. One rectifier circuit 40 is connected to the plurality of first conductors 20. By using an array antenna in which the plurality of first conductors 20 is arranged, the characteristics of the antenna device 10P can be improved. In particular, the gain of the antenna device 10P can be improved by connecting one rectifier circuit 40 to the plurality of first conductors 20.

In a case where the antenna device has the plurality of first conductors 20, the orientation of each of the first conductors 20 constituting the array can be optionally adjusted. For example, as illustrated in FIG. 29, a part of the first conductors (the first conductors denoted by reference numeral 20A in the drawing) is disposed to cause loop surfaces LS of the part of the first conductors to be disposed along the X direction (an example of the first direction). Furthermore, the other of the first conductors (the first conductors denoted by reference numeral 20B in the drawing) is disposed to cause the loop surfaces LS of the other of the first conductors to be disposed along the Y direction (an example of the second direction) orthogonal to the X direction. With such a configuration, electromagnetic waves of various polarized waves can be received.

In a case where the antenna device includes the plurality of first conductors 20, the first conductors having different loop lengths may be arranged. With this arrangement, an antenna device that can support a plurality of frequencies assumed as wireless power transfer standards can be realized. Examples of the plurality of frequencies include, for example, 24 GHZ and 28 GHz. For each of the reception frequencies, the length of the loop of the first conductor 20 and the minimum length of an outer edge part 33 of a metal plate 30 are set within the same range as in the first embodiment. With this arrangement, an antenna device optimized for each reception frequency can be obtained.

In a case where the antenna device includes the plurality of first conductors 20 and one rectifier circuit 40 is connected to the plurality of first conductors 20, a phase shifter may be connected between each of the first conductors 20 and the rectifier circuit 40. With such a configuration, directivity can be controlled, and an effect of receiving electromagnetic waves coming from various directions can be obtained.

Note that the number and the positions of the first conductors 20 are not limited to the illustrated example, and may be an appropriate number and the like.

### [Application Example]

An application example of the present technology will be described. As illustrated in FIG. 30A, the rectifier circuit 40 is connected to the first conductor 20, and a load 90 is connected to the rectifier circuit 40. The DC voltage output from the rectifier circuit 40 is supplied to the load 90. As the load 90, a battery, a sensor, a communication module, a speaker (for example, a small speaker applied to a wireless earphone), a display, and the like are exemplified. The load 90 is connected to the antenna device including the first conductor 20 and the rectifier circuit 40 to constitute an electronic apparatus 100.

The rectifier circuit 40 and the load 90 do not necessarily need to be directly connected to each other. For example, as illustrated in FIG. 30B, a DC-DC converter 91 that performs voltage boosting and voltage bucking and a known power supply circuit 92 that controls input power can be connected between the load 90 and the rectifier circuit 40.

For example, in a case where the height of the antenna device can be reduced as in the fourth embodiment, the height of the electronic apparatus 100 itself on which the antenna device is mounted can be further reduced. That is, because the device can be made more inconspicuous than necessary, the appearance of the electronic apparatus 100 can be improved. Furthermore, in a case where the electronic apparatus 100 is a wearable device worn by a user, the sense of use of the electronic apparatus 100 felt by the user can be made favorable.

### [Modifications]

Although the embodiments of the present technology are heretofore described specifically, the contents of the present technology are not limited to the above-described embodiments, and various modifications based on the technical idea of the present technology can be made.

### (First Modification)

The above embodiments can be appropriately combined with each other. FIG. 31A is a perspective view of an antenna device (an antenna device 10Q) according to the present modification, and FIG. 31B is a cross-sectional view in a case where the antenna device 100 is cut along a cutting line QQ-QQ in FIG. 31A.

The antenna device 100 has a configuration in which the substrate 60 is stacked on the lower side of the substrate 50 as described in the third embodiment. In addition, the antenna device 100 includes the metal pattern 65 described in the eighth embodiment. The metal pattern 65 is disposed inside the substrate 60. In this manner, each of the above-described embodiments can be appropriately combined with the others.

### (Second Modification)

FIG. 32A is a perspective view of an antenna device (an antenna device 10R) according to the present modification, and FIG. 32B is a cross-sectional view in a case where the antenna device 10R is cut along a cutting line RR-RR in FIG. 32A.

As illustrated in FIGS. 32A and 32B, the first conductor 20 has a configuration in which ends of the first element 21 and the second element 22 are fixed (connected) to each other by a solder bump 23E and a solder bump 24E. The loop surface LS is formed by being partitioned by the first element 21, the second element 22, the solder bump 23E, and the solder bump 24E. In this manner, the first conductor 20 is not limited to a configuration in which each of the elements is integrally and continuously connected to the other elements by the same member.

### (Third Modification)

FIG. 33A is a perspective view of an antenna device (an antenna device 10S) according to the present modification, and FIG. 33B is a partially enlarged view in a case where a portion of the antenna device 10S illustrated in FIG. 33A is enlarged.

Furthermore, FIG. 33C is a diagram schematically illustrating a connection mode between the first conductor of the antenna device 10S and the rectifier circuit 40.

The antenna device 10S includes, for example, two first conductors (a first conductor 201 and a first conductor 202) connected to each other. The first conductor 201 formed as a loop antenna forms a loop surface LSA, and the first conductor 202 formed as a loop antenna forms a loop surface LSB. A second element 211 of the first conductor 201 includes an element 211A and an element 211B separated into left and right with a gap GA interposed therebetween. Furthermore, a second element 212 of the first conductor 202 includes an element 212A and an element 212B separated into left and right with a gap GA interposed therebetween. The element 211B of the first conductor 201 and the element 212A of the first conductor 202 are connected with each other. The rectifier circuit 40 is connected to, for example, the end near the center of the element 211A and the end near the center of the element 211B. The rectifier circuit 40 is connected to each element by a solder bump or the like.

According to the present modification, the magnetic field generated inside the plurality of loop surfaces becomes strong, and the gain of the antenna device 10S is improved. Note that the number of loops is not limited to two as in the present modification, and may be three or more.

### (Fourth Modification)

The present modification is a modification related to the shape of the metal plate 30. In the above-described embodiments, the metal plate 30 has a rectangular shape in plan view, but the present modification is not limited thereto. FIG. 34 is a view for explaining a metal plate (a metal plate 301) according to the present modification. The metal plate 301 has a base 301A having a plate shape and disposed to face the second main surface 52 side of the substrate 50. The base 301A has a boundary part 302A and a boundary part 302B at both ends in the X direction. Furthermore, the metal plate 301 has a bent part 303A bent upward with the boundary part 302A as a boundary.

Moreover, the metal plate 301 has a bent part 303B bent upward with the boundary part 302B as a boundary. The substrate 50 is surrounded on the left and right sides in the X direction by the bent part 303A and the bent part 303B. Note that, in the example in FIG. 34, the minimum length of the outer edge part of the metal plate 301 corresponds to the length of an end 304A of the bent part 303A or the length of an end 304B of the bent part 303B.

FIG. 35 is a diagram for explaining another example of the metal plate 30. A metal plate 305 illustrated in FIG. 35 has a shape that is curved while protruding downward (−Z direction) with respect to the substrate 50. The substrate 50 is surrounded on the left and right sides in the X direction by the metal plate 305. Note that, in the example in FIG. 34, the minimum length of the outer edge part of the metal plate 305 corresponds to the length of the end 305A or the end 305B, each having a linear shape, of the metal plate 305.

In the examples illustrated in FIGS. 34 and 35, the metal plate has a shape that partially covers the periphery of the first conductor 20. With this arrangement, electrical coupling between the first conductor 20 and other components can be prevented, and a decrease in the gain of the entire antenna device can be suppressed.

FIG. 36 is a diagram for explaining another example of the metal plate 30. As illustrated in FIG. 36, the metal plate 30 may have an absent portion 310 formed by partially cutting out the metal plate. Even in this case, because the absent portion 310 is not the outer edge, the minimum length of the outer edge part of the metal plate 305 corresponds to the length of the third side portion 33C or the fourth side portion 33D of the metal plate 30. By providing the absent portion 310, interference between the metal plate 30 and wiring and other components can be avoided.

### (Other Modifications)

The loop surface formed by the first conductor does not need to be a surface strictly perpendicular to the metal plate. That is, the first conductor may be provided such that the loop surface is slightly inclined with respect to the metal plate.

Furthermore, for example, a plurality of technologies related to the present technology can be implemented independently as a single entity as long as there is no contradiction. It goes without saying that any plurality of present technologies can be implemented in combination. For example, a part or all of the present technologies described in any of the embodiments can be implemented in combination with a part or all of the present technologies described in other embodiments. Furthermore, a part or all of any of the above-described present technologies can be implemented together with another technology that is not described above.

Furthermore, the configurations, methods, steps, shapes, materials, numerical values, and the like described in the embodiments and the modifications are merely examples, and configurations, methods, steps, shapes, materials, numerical values, and the like different from those described above may be used as necessary. Furthermore, the materials exemplified in the embodiments and modifications described above may be used alone or in combination of two or more unless otherwise specified.

Furthermore, the constituent elements described in the embodiments and the modifications can be appropriately combined.

Note that, the effects described in the present description are merely examples and are not limited, and other effects may also be achieved.

The present technology can also adopt the following configurations.

(1)

An antenna device including:
a first conductor having a loop shape;
a rectifier circuit connected to the first conductor; and
a second conductor having a plate shape and including a main surface extending in a direction substantially orthogonal to a loop surface of the first conductor, and an outer edge part of the main surface,
in which
the first conductor has a loop whose length with respect to a wavelength at a reception frequency is larger than 0.15, and the second conductor has the outer edge part whose minimum length with respect to the length of the loop of the first conductor is larger than 0.4.

(2)

The antenna device according to (1), in which
the first conductor has the loop whose length with respect to the wavelength at the reception frequency is larger than 0.2, and the second conductor has the outer edge part whose minimum length with respect to the length of the loop of the first conductor is larger than 0.5.

(3)

The antenna device according to (1) or (2), further including
a substrate, in which
at least a part of the first conductor is formed on a surface of the substrate.

(4)

The antenna device according to (3), in which
the first conductor includes a first element, a second element disposed to face the first element, a third element extending in a direction substantially orthogonal to an extending direction of the first element and the second element, and a fourth element disposed to face the third element,
the loop surface is formed by the first element, the second element, the third element, and the fourth element, and
the first element and the second element each have a length in the loop of the loop surface, the length being larger than a length of each of the third element and the fourth element.

(5)

The antenna device according to (4), in which
the third element and the fourth element are each disposed in a through via formed in the substrate.

(6)

The antenna device according to (5), further including
a plurality of the third elements and a plurality of the fourth elements, in which
the plurality of third elements and the plurality of fourth elements are each disposed in different ones of the through vias.

(7)

The antenna device according to any one of (4) to (6), in which
the first element is formed on a first main surface of the substrate, and the second element is formed on a second main surface opposite to the first main surface,
the substrate is stacked with an other substrate to cause a first main surface of the other substrate to be in contact with the second main surface of the substrate, and
the second conductor is formed on a second main surface opposite to the first main surface of the other substrate.

(8)

The antenna device according to any one of (4) to (6), in which
the first element is formed on a first main surface of the substrate, and the second element is formed on a second main surface opposite to the first main surface,
the second conductor is formed on the second main surface of the substrate by using a metal layer that is a same as the second element, and
the metal layer between the second element and the second conductor is removed.

(9)

The antenna device according to (4), in which
the first element is disposed at a position where a distance to the second conductor in a thickness direction of the substrate is larger than a distance from the second element, and
the first element has an area that is larger than an area of the second element.

(10)

The antenna device according to (9), in which
the first element and the second element each have a rectangular shape,
the first element and the second element have same lengths in a transverse direction, and the first element has a length in a longitudinal direction larger than a length of the second element in a longitudinal direction.

(11)

The antenna device according to (9), in which
the first element and the second element each have a rectangular shape,
the first element and the second element have same lengths in a longitudinal direction, and the first element has a length in a transverse direction larger than a length of the second element in a transverse direction.

(12)

The antenna device according to any one of (3) to (11), further including
a metal pattern separated from the first conductor.

(13)

The antenna device according to (12), in which
the metal pattern is formed on the same surface as a surface of the substrate on which the first conductor is formed.

(14)

The antenna device according to (13), in which
the first conductor is formed on a first main surface and a second main surface of the substrate, and
the metal pattern is formed on the first main surface and the second main surface of the substrate.

(15)

The antenna device according to (14), in which
the substrate is stacked with an other substrate to cause a first main surface of the other substrate to be in contact with the second main surface of the substrate, and
the second conductor is formed on a second main surface of the other substrate.

(16)

The antenna device according to any one of (3) to (13), further including
a fixing part that fixes the substrate and the second conductor to each other.

(17)

The antenna device according to any one of (1) to (16), in which
the first conductor is formed on a surface of a housing in which the rectifier circuit is housed.

(18)

The antenna device according to any one of (1) to (16), further including
a matching circuit, in which
the rectifier circuit is connected to the first conductor via the matching circuit.

(19)

The antenna device according to any one of (3) to (13), in which
the substrate is connected with a heat dissipation member.

(20)

An electronic apparatus including:
the antenna device according to any one of (1) to (19); and
a load connected to the rectifier circuit.

(21)

The antenna device according to (16), in which
the rectifier circuit is disposed in a space formed between the substrate and the second conductor.

(22)

The antenna device according to any one of (1) to (21), in which
the first conductor has a shape in which an absent portion is formed in a part of the loop.

(23)

The antenna device according to (22), in which
the absent portion has a linear shape or a comb shape.

(24)

The antenna device according to (5), in which
the substrate is provided with a third conductor in an inside, the third conductor being provided to penetrate the loop surface.

(25)

The antenna device according to any one of (1) to (24), further including:
a plurality of the first conductors; and
a rectifier circuit connected to each of the first conductors, in which
the second conductor has a main surface that extends in a direction substantially orthogonal to all of the loop surfaces of the plurality of first conductors.

(26)

The antenna device according to (25), in which,
among the plurality of first conductors, a part of the first conductors is disposed to cause the loop surfaces of the part of the first conductors to be disposed along a first direction, and an other of the first conductors is disposed to cause the loop surfaces of the other of the first conductors to be disposed along a second direction orthogonal to the first direction.

### REFERENCE SIGNS LIST

10A to 10S Antenna device
20 First conductor
21 First element
22 Second element
23 Third element
24 Fourth element
30 Metal plate
33 Outer edge part
40 Rectifier circuit
41 Matching circuit
50 Substrate
53 Through via
54 Through via
57 Removed part
65 Metal pattern
70 Heat dissipation member
75 Fixing part
85 Conductor part
90 Load
100 Electronic apparatus

1. An antenna device comprising:
a first conductor having a loop shape;
a rectifier circuit connected to the first conductor; and
a second conductor having a plate shape and including a main surface extending in a direction substantially orthogonal to a loop surface of the first conductor, and an outer edge part of the main surface, wherein
the first conductor has a loop whose length with respect to a wavelength at a reception frequency is larger than 0.15, and the second conductor has the outer edge part whose minimum length with respect to the length of the loop of the first conductor is larger than 0.4.

2. The antenna device according to claim 1, wherein
the first conductor has the loop whose length with respect to the wavelength at the reception frequency is larger than 0.2, and the second conductor has the outer edge part whose minimum length with respect to the length of the loop of the first conductor is larger than 0.5.

3. The antenna device according to claim 1, further comprising a substrate, wherein
at least a part of the first conductor is formed on a surface of the substrate.

4. The antenna device according to claim 3, wherein
the first conductor includes a first element, a second element disposed to face the first element, a third element extending in a direction substantially orthogonal to an extending direction of the first element and the second element, and a fourth element disposed to face the third element,
the loop surface is formed by the first element, the second element, the third element, and the fourth element, and
the first element and the second element each have a length in the loop of the loop surface, the length being larger than a length of each of the third element and the fourth element.

5. The antenna device according to claim 4, wherein
the third element and the fourth element are each disposed in a through via formed in the substrate.

6. The antenna device according to claim 5, further comprising
a plurality of the third elements and a plurality of the fourth elements, wherein
the plurality of third elements and the plurality of fourth elements are each disposed in different ones of the through vias.

7. The antenna device according to claim 4, wherein
the first element is formed on a first main surface of the substrate, and the second element is formed on a second main surface opposite to the first main surface,
the substrate is stacked with another substrate to cause a first main surface of the another substrate to be in contact with the second main surface of the substrate, and
the second conductor is formed on a second main surface opposite to the first main surface of the another substrate.

8. The antenna device according to claim 4, wherein
the first element is formed on a first main surface of the substrate, and the second element is formed on a second main surface opposite to the first main surface,
the second conductor is formed on the second main surface of the substrate by using a metal layer that is a same as the second element, and
the metal layer between the second element and the second conductor is removed.

9. The antenna device according to claim 4, wherein
the first element is disposed at a position where a distance to the second conductor in a thickness direction of the substrate is larger than a distance from the second element, and
the first element has an area that is larger than an area of the second element.

10. The antenna device according to claim 9, wherein
the first element and the second element each have a rectangular shape,
the first element and the second element have same lengths in a transverse direction, and the first element has a length in a longitudinal direction larger than a length of the second element in a longitudinal direction.

11. The antenna device according to claim 9, wherein
the first element and the second element each have a rectangular shape,
the first element and the second element have same lengths in a longitudinal direction, and the first element has a length in a transverse direction larger than a length of the second element in a transverse direction.

12. The antenna device according to claim 3, further comprising
a metal pattern separated from the first conductor.

13. The antenna device according to claim 12, wherein
the metal pattern is formed on a same surface as a surface of the substrate on which the first conductor is formed.

14. The antenna device according to claim 13, wherein
the first conductor is formed on a first main surface and a second main surface of the substrate, and
the metal pattern is formed on the first main surface and the second main surface of the substrate.

15. The antenna device according to claim 14, wherein
the substrate is stacked with another substrate to cause a first main surface of the another substrate to be in contact with the second main surface of the substrate, and
the second conductor is formed on a second main surface of the another substrate.

16. The antenna device according to claim 3, further comprising
a fixing part that fixes the substrate and the second conductor to each other.

17. The antenna device according to claim 1, wherein
the first conductor is formed on a surface of a housing in which the rectifier circuit is housed.

18. The antenna device according to claim 1, further comprising
a matching circuit, wherein
the rectifier circuit is connected to the first conductor via the matching circuit.

19. The antenna device according to claim 3, wherein
the substrate is connected with a heat dissipation member.

20. An electronic apparatus comprising:
the antenna device according to claim 1; and
a load connected to the rectifier circuit.
